(19) United States
(12) Patent Application Publication
(10) Pub. No.: US 2025/0206563 A1
(43) Pub. Date: Jun. 26, 2025

(54) FILM MANUFACTURING METHOD, FILM, WOUND BODY, CONNECTION STRUCTURE, METHOD FOR MANUFACTURING CONNECTION STRUCTURE, AND REMOVING DEVICE

(71) Applicant: Resonac Corporation, Tokyo (JP)

(72) Inventors: Tomoki MORIJIRI, Tokyo (JP); Mitsuyoshi SHIMAMURA, Tokyo (JP); Mayumi SATO, Tokyo (JP); Kenta KIKUCHI, Tokyo (JP)

(21) Appl. No.: 18/843,562

(22) PCT Filed: Mar. 2, 2023
(86) PCT No.: PCT/JP2023/007797

§ 371 Date: Sep. 3, 2024

(30) Foreign Application Priority Data
Mar. 4, 2022 (JP) 2022-033679

(51) Int. Cl. B65H 41/00; C09J 7/30; C09J 7/40; C09J 9/02

(52) U.S. Cl. CPC B65H 41/00; C09J 7/30; C09J 7/40; C09J 9/02; B65H 2511/20; B65H 2511/52; B65H 2701/377

(57) ABSTRACT

A film manufacturing method includes a removing step of removing at least one removal target adhesive film piece from an original film having a plurality of adhesive film pieces provided on a long release film. A film includes a long release film, a plurality of adhesive film pieces, and a non-adhesive region, the plurality of adhesive film pieces include a first adhesive film piece and a second adhesive film piece which are adjacent to each other through the non-adhesive region and a adhesive film piece and a fourth adhesive film piece which are adjacent to each other through a non-adhesive region, and a separation distance between the first adhesive film piece and the second adhesive film piece is different from a separation distance between the third adhesive film piece and the fourth adhesive film piece.

### TECHNICAL FIELD

The present disclosure relates to a film manufacturing method, a film, a wound body, a connection structure, a method for manufacturing a connection structure, and a removing device.

### BACKGROUND ART

In recent years, devices such as smartphones, personal computers, earphones, smart watches, and wearable devices have become more functional, smaller, thinner, and more sophisticated in design. In addition, the sensors, parts, and circuit boards mounted on devices have become more highly functional and complex. Along with this, there are an increasing number of cases where low heat resistant materials are used for some or all of the sensors, components, boards, and the like, where low heat resistant sensors, components, boards, and the like are mounted on devices, or where other components are connected at high temperatures in close positions to low heat resistant sensors, components, boards, and the like. Furthermore, “connecting” includes the meanings of bonding, mounting, and installation. As a result, there is a demand for technology that allows connecting other components only to one or more predetermined positions on sensors, components, boards, and the like. Furthermore, the positions at which other members are connected to sensors, components, boards, and the like vary depending on the type of device and the like.

### CITATION LIST

### Patent Literature

Patent Literature 1: International Publication WO 2018/066411

### SUMMARY OF INVENTION

### Technical Problem

Therefore, it is conceivable to use a film having a plurality of adhesive film pieces provided on a release film as described in Patent Literature 1, and to attach the adhesive film pieces only to one or more predetermined positions on a sensor, component, board, and the like. However, in view of the common technical knowledge in this technical field that aims to decrease cost by effectively using the film, the adhesive film pieces are arranged at equal intervals to be close to each other. In this way, when the plurality of adhesive film pieces are arranged at equal intervals to be close to each other, it is not easy to attach the adhesive film pieces to various positions.

Therefore, an object of the present disclosure is to provide a film manufacturing method, a film, a wound body, a connection structure, a method for manufacturing a connection structure, and a removing device capable of attaching an adhesive film piece to various positions.

### Solution to Problem

A film manufacturing method according to the present disclosure includes: a removing step of removing at least one removal target adhesive film piece among a plurality of adhesive film pieces from an original film having a plurality of adhesive film pieces provided on a long release film.

In the film manufacturing method, it is possible to reduce the number of the adhesive film pieces provided on the release film by removing the removal target adhesive film piece from the original film. Then, it is possible to change the arrangement of the adhesive film pieces provided on the release film by changing the positions and number of the adhesive film pieces that will become the removal target adhesive film pieces. Accordingly, it is possible to manufacture the film in which the adhesive film piece can be attached to various positions. In addition, for example, when the original film has the defective adhesive film piece, it is possible to manufacture the film from which the defective adhesive film piece is removed by removing the defective adhesive film piece as the removal target adhesive film piece.

Incidentally, it is possible to change the arrangement of the adhesive film pieces provided on the release film by preparing a plurality of molds for punching out the adhesive film piece. However, a problem arises in that cost increases when preparing a plurality of molds. In contrast, in the film manufacturing method, since it is possible to change the arrangement of the adhesive film pieces provided on the release film by removing the removal target adhesive film piece from the original film, it is possible to suppress an increase in cost compared to the case in which a plurality of molds are prepared.

Further, a dispenser that drops a liquid adhesive can be used to provide a plurality of adhesives at any desired positions on the release film. However, in the liquid adhesives, high aspect ratio structures are difficult to be made, edges tend to become rounded due to surface tension, and dimensional accuracy decreases due to bleeding. In contrast, in the film manufacturing method, since the removal target adhesive film piece among the plurality of adhesive film pieces provided on the release film is removed, these problems can be solved.

In the removing step, the removal target adhesive film piece may be removed by transferring the removal target adhesive film piece from the original film to the adhesion body to be able to contact and separate from the original film. In the film manufacturing method, since the removal target adhesive film piece is transferred from the original film to the adhesion body, it is possible to appropriately remove the removal target adhesive film piece.

In the removing step, the removal target adhesive film piece transferred to a first adhesion roller may be transferred to a second adhesion roller not contacting the original film by using the first adhesion roller as the adhesion body. In the film manufacturing method, since the removal target adhesive film piece transferred to the first adhesion roller is transferred to the second adhesion roller, it is possible to suppress the removal target adhesive film piece transferred to the first adhesion roller from being returned to the original film.

In the removing step, the adhesion tape may be brought into contact with and separate from the original film while being transported by using the adhesion tape as the adhesion body. In the film manufacturing method, since the adhesion tape is brought into contact with and separate from the original film while being transported, it is possible to suppress the removal target adhesive film piece transferred to the adhesion tape from being returned to the original film.

The film manufacturing method may further include: a detection step of detecting the removal target adhesive film piece, and in the removing step, the removal target adhesive film piece detected by the detection step is removed from the original film. In the film manufacturing method, since the removal target adhesive film piece is detected and the detected removal target adhesive film piece is removed, the removal of the removal target adhesive film piece can be automated.

In the detection step, the adhesive film piece at a predetermined position among the plurality of adhesive film pieces may be detected as the removal target adhesive film piece. In the film manufacturing method, since the adhesive film pieces at the predetermined positions among the plurality of adhesive film pieces are detected and removed as the removal target adhesive film pieces, the arrangement of the adhesive film pieces provided on the release film can be patterned. Accordingly, for example, it is possible to manufacture the film in which the plurality of adhesive film pieces are attached to a plurality of members in the same pattern arrangement.

In the detection step, when the plurality of adhesive film pieces are divided into a plurality of adhesive film piece groups arranged in the longitudinal direction of the release film, the adhesive film piece at the same position among the plurality of adhesive film piece groups may be detected as the removal target adhesive film piece. In the film manufacturing method, since the adhesive film pieces at the same position among the plurality of adhesive film piece groups of the original film are detected and removed as the removal target adhesive film pieces, the arrangement of the adhesive film pieces in each adhesive film piece group of the film can be made the same. Accordingly, for example, it is possible to manufacture the film in which the plurality of adhesive film pieces are attached to a plurality of members in the same pattern arrangement.

Incidentally, the arrangement of the adhesive film pieces in each adhesive film piece group can be made the same by forming the plurality of adhesive film pieces provided in each adhesive film piece group by punching with a mold. However, since it is necessary to provide a large mold when one adhesive film piece group is long in the longitudinal direction of the release film, a problem arises in that cost increases. In contrast, in the film manufacturing method, the arrangement of the adhesive film pieces in each adhesive film piece group can be made the same just by removing the removal target adhesive film piece no matter how long one adhesive film piece group is in the longitudinal direction of the release film 2. Therefore, it is possible to suppress an increase in cost compared to the case in which a mold is prepared.

In the detection step, the defective adhesive film piece among the plurality of adhesive film pieces may be detected as the removal target adhesive film piece. In the film manufacturing method, since the defective adhesive film piece is detected and removed as the removal target adhesive film piece, it is possible to manufacture the film without the defective adhesive film piece.

Incidentally, it is also possible to mark the defective adhesive film pieces or the vicinity of the defective adhesive film pieces by inkjet or laser marking, or the like, and to use the mark as a guide to prevent the defective adhesive film pieces from being attached. However, when marking is performed by inkjet or laser marking, there are problems such as foreign matter defects due to inkjet ink, burning due to the laser, foreign matter defects due to dust generation, and damage to the release film. In contrast, in the film manufacturing method, since the defective adhesive film piece is detected and removed as the removal target adhesive film piece, these problems can be solved.

The film manufacturing method may further include: an original film manufacturing step of manufacturing an original film. In the film manufacturing method, since the original film manufacturing step of manufacturing the original film is provided, it is possible to freely set the arrangement of the plurality of adhesive film pieces in the original film.

The original film manufacturing step may include an adhesive film layer forming step of forming an adhesive film layer on an entire surface of the release film, an adhesive film layer cutting step of cutting the adhesive film layer along an outline forming an outer shape of the plurality of adhesive film pieces, and a margin releasing step of releasing a margin portion as a portion other than the plurality of adhesive film pieces in the adhesive film layer from the release film along the cut outline. In the film manufacturing method, the adhesive film layer is formed on the entire surface of the release film, the adhesive film layer is cut along the outline, and the margin portion is released from the release film along the cut outline. Accordingly, it is possible to easily provide the plurality of adhesive film pieces on the release film.

The plurality of adhesive film pieces may be conductive. In the film manufacturing method, since the plurality of adhesive film pieces are conductive, the members connected through the adhesive film piece can be made electrically conductive.

A film according to the present disclosure includes: a long release film; a plurality of adhesive film pieces which are provided on the release film and separated from each other; and a non-adhesive region which is provided on the release film not to have the plurality of adhesive film pieces, in which the plurality of adhesive film pieces include a first adhesive film piece and a second adhesive film piece which are adjacent to each other through the non-adhesive region and a third adhesive film piece and a fourth adhesive film piece which are adjacent to each other through the non-adhesive region, and in which a separation distance between the first adhesive film piece and the second adhesive film piece is different from a separation distance between the third adhesive film piece and the fourth adhesive film piece.

In the film, since the separation distance between the first adhesive film piece and the second adhesive film piece is different from the separation distance between the third adhesive film piece and the fourth adhesive film piece, the adhesive film piece can be attached to various positions compared to the case in which the plurality of adhesive film pieces have the same separation distance.

The first adhesive film piece and the second adhesive film piece may be adjacent to each other in the longitudinal direction of the release film, and the third adhesive film piece and the fourth adhesive film piece may be adjacent to each other in the longitudinal direction. In the film, since the first adhesive film piece and the second adhesive film piece are adjacent to each other in the longitudinal direction and the third adhesive film piece and the fourth adhesive film piece are adjacent to each other in the longitudinal direction, the adhesive film piece can be attached to various positions among the longitudinal direction.

The first adhesive film piece and the second adhesive film piece may be adjacent to each other in the width direction of the release film, and the third adhesive film piece and the fourth adhesive film piece may be adjacent to each other in the width direction. In the film, since the first adhesive film piece and the second adhesive film piece are adjacent to each other in the width direction of the release film and the third adhesive film piece and the fourth adhesive film piece are adjacent to each other in the width direction, the adhesive film piece can be attached to various positions among the width direction.

The non-adhesive region may have a first region in which the separation distance between the adjacent adhesive film pieces is longer than the adhesive film piece. In the film, since the non-adhesive region has the first region in which the separation distance between the adjacent adhesive film pieces is longer than the adhesive film piece, the adhesive film piece can be attached to more various positions.

The non-adhesive region may have a second region in which the separation distance between the adjacent adhesive film pieces is shorter than the adhesive film piece. In the film, since the non-adhesive region has the second region in which the separation distance between the adjacent adhesive film pieces is shorter than the adhesive film piece, the adhesive film piece can be attached to more various positions.

The non-adhesive region may have a third region in which the separation distance between the adjacent adhesive film pieces is shorter than the separation distance of the first region. In the film, since the non-adhesive region has the third region in which the separation distance between the adjacent adhesive film pieces is shorter than the separation distance between the adjacent adhesive film pieces in the first region, the adhesive film piece can be attached to more various positions.

The separation distance between the first adhesive film piece and the second adhesive film piece may be longer than the maximum length of the first adhesive film piece and the second adhesive film piece in the direction in which the first adhesive film piece and the second adhesive film piece are separated from each other. In the film, the separation distance between the first adhesive film piece and the second adhesive film piece is longer than the maximum length of the first adhesive film piece and the second adhesive film piece in the direction in which the first adhesive film piece and the second adhesive film piece are separated from each other. Therefore, the first adhesive film piece and the second adhesive film piece can be attached to a position farther than the maximum length of the first adhesive film piece and the second adhesive film piece in the direction in which the first adhesive film piece and the second adhesive film piece are separated from each other without attaching the adhesive film piece between the first adhesive film piece and the second adhesive film piece.

The separation distance between the third adhesive film piece and the fourth adhesive film piece may be shorter than the maximum length of the third adhesive film piece and the fourth adhesive film piece in the direction in which the third adhesive film piece and the fourth adhesive film piece are separated from each other. In the film, the separation distance between the third adhesive film piece and the fourth adhesive film piece is shorter than the maximum length of the third adhesive film piece and the fourth adhesive film piece in the direction in which the third adhesive film piece and the fourth adhesive film piece are separated from each other. Therefore, the third adhesive film piece and the third adhesive film piece can be attached to a position closer than the maximum length of the third adhesive film piece and the fourth adhesive film piece in the direction in which the third adhesive film piece and the fourth adhesive film piece are separated from each other without attaching the adhesive film piece between the third adhesive film piece and the fourth adhesive film piece.

The separation distance between the third adhesive film piece and the fourth adhesive film piece may be shorter than the separation distance between the first adhesive film piece and the second adhesive film piece. In the film, since the separation distance between the third adhesive film piece and the fourth adhesive film piece is shorter than the separation distance between the first adhesive film piece and the second adhesive film piece, the adhesive film piece can be attached to more various positions.

The film may further include: a half cut which is formed in the release film, and the half cut is formed in the non-adhesive region between the first adhesive film piece and the second adhesive film piece. In the film, the half cut is formed in the non-adhesive region between the first adhesive film piece and the second adhesive film piece. Therefore, for example, when another adhesive film piece provided between the first adhesive film piece and the second adhesive film piece is removed during the manufacturing of the film, it is possible to determine whether or not the trace is due to the removal of the adhesive film piece.

The third adhesive film piece and the fourth adhesive film piece may be adjacent to each other in a longitudinal direction of the release film, and the separation distance between the third adhesive film piece and the fourth adhesive film piece in the longitudinal direction may be 20 mm or less. In the film, the third adhesive film piece and the fourth adhesive film piece are adjacent to each other in the longitudinal direction, and the separation distance between the third adhesive film piece and the fourth adhesive film piece in the longitudinal direction is 20 mm or less. Therefore, the transportation distance of the film when attaching the third adhesive film piece and the fourth adhesive film piece can be shortened and the film can be effectively used to decrease cost.

The plurality of adhesive film pieces may form a plurality of adhesive film piece groups arranged in a longitudinal direction of the release film, and an arrangement of the adhesive film pieces may be the same in the plurality of adhesive film piece groups. In the film, since the arrangement of the adhesive film pieces is the same in the plurality of adhesive film piece groups, the adhesive film piece can be efficiently attached to the member having the same attachment position of the adhesive film piece.

The separation distance between the adjacent adhesive film piece groups in the longitudinal direction of the release film may be 20 mm or less. In the film, the separation distance between the adjacent adhesive film piece groups in the longitudinal direction of the release film is 20 mm or less. Therefore, when the adjacent adhesive film piece groups are attached to different members, the transportation distance of the film can be shortened and the film can be effectively used to decrease cost.

The plurality of adhesive film pieces may be separated from edges of the release film in a width direction of the release film. In the film, since the plurality of adhesive film pieces are separated from the edges of the release film in the width direction of the release film, it is possible to suppress the adhesive film piece from being released from the release film when the ends of the release film interfere with other members.

The plurality of adhesive film pieces may be arranged in one row in a longitudinal direction of the release film. In the film, since the plurality of adhesive film pieces are arranged in one row in the longitudinal direction of the release film, the adhesive film piece can be easily attached.

At least a part of the plurality of adhesive film pieces may have a hole. In the film, since at least a part of the plurality of adhesive film pieces has the hole, the adhesive film piece can be appropriately attached to a portion having a center portion where the adhesive film piece is not desired to be attached.

The plurality of adhesive film pieces may have the same shape. In the film, since the plurality of adhesive film pieces have the same shape, the adhesive film piece can be efficiently attached to the plurality of attachment surfaces having the same shape.

The adhesive film piece may be conductive. In the film, since the adhesive film piece is conductive, two members connected through the adhesive film piece can be made electrically conductive.

The adhesive film piece may contain conductive particles. In the film, since the adhesive film piece contains the conductive particles, the adhesive film piece can have anisotropic conductivity.

A wound body according to the present disclosure includes any one of the above-described films and a core on which the film is wound. In the wound body, since any one of the above-described films is wound on the core, the adhesive film piece can be attached to various positions.

A connection structure according to the present disclosure includes: a first member that has a first attachment surface; a second member that has a second attachment surface; and any one of the above-described adhesive film pieces that connect the first attachment surface and the second attachment surface. In the connection structure, since the first member and the second member are connected by any one of the above-described adhesive film pieces, it is possible to obtain a connection structure in which the adhesive film piece is appropriately attached to the first attachment surface and the second attachment surface even when the positions of the first attachment surface and the second attachment surface are various.

A method for manufacturing a connection structure according to the present disclosure includes: a preparation step of preparing any one of the above-described films; and a connection step of connecting the first attachment surface of the first member and the second attachment surface of the second member through the adhesive film piece of the film. In the method for manufacturing the connection structure, since the first attachment surface of the first member and the second attachment surface of the second member are connected through the adhesive film piece of any one of the above-described films, it is possible to manufacture the connection structure in which the adhesive film piece is appropriately attached to the first attachment surface and the second attachment surface even when the positions of the first attachment surface and the second attachment surface are various.

A removing device according to the present disclosure includes: an unwinding shaft on which a wound body, formed by winding an original film having a plurality of adhesive film pieces provided on a long release film, is set; a winding shaft which winds up the original film unwound from the wound body; a first adhesion roller to which at least one removal target adhesive film piece among the plurality of adhesive film pieces is transferred from the original film; a second adhesion roller to which the removal target adhesive film piece transferred to the first adhesion roller is transferred by contacting or approaching the first adhesion roller; and a drive mechanism which moves the first adhesion roller to be able to contact and separate from the original film reaching the winding shaft from the unwinding shaft.

The removing device may further include: a sensor which detects the adhesive film piece at a predetermined position among the plurality of adhesive film pieces as the removal target adhesive film piece, in which the drive mechanism moves the first adhesion roller close to the original film so that the first adhesion roller contacts the removal target adhesive film at a timing at which the removal target adhesive film piece detected by the sensor reaches.

The removing device may further includes: an inspection machine which inspects the plurality of adhesive film pieces provided on the original film and detects the adhesive film piece determined to be defective as the removal target adhesive film piece, in which the drive mechanism moves the first adhesion roller close to the original film so that the first adhesion roller contacts the removal target adhesive film piece at a timing at which the removal target adhesive film piece detected by the inspection machine reaches.

A removing device according to the present disclosure includes: an unwinding shaft on which a wound body, formed by winding an original film having a plurality of adhesive film pieces provided on a long release film, is set; a winding shaft which winds up the original film unwound from the wound body; an adhesion tape to which at least one removal target adhesive film piece of the plurality of adhesive film pieces is transferred from the original film; and a drive mechanism which moves the adhesion tape to be able to contact and separate from the original film reaching the winding shaft from the unwinding shaft.

The removing device may further include: a sensor which detects the adhesive film piece at a predetermined position among the plurality of adhesive film pieces as the removal target adhesive film piece, in which the drive mechanism moves the adhesion tape close to the original film so that the adhesion tape contacts the removal target adhesive film at a timing at which the removal target adhesive film piece detected by the sensor reaches.

The removing device may further include: an inspection machine which inspects the plurality of adhesive film pieces provided on the original film and detects the adhesive film piece determined to be defective as the removal target adhesive film piece, in which the drive mechanism moves the adhesion tape close to the original film so that the adhesion tape contacts the removal target adhesive film piece at a timing at which the removal target adhesive film piece detected by the inspection machine reaches.

### Advantageous Effects of Invention

According to the present disclosure, the adhesive film piece can be attached to various positions.

### BRIEF DESCRIPTION OF DRAWINGS

FIG. 1 is a flowchart illustrating a film manufacturing method according to this embodiment.

FIG. 2 is a plan view illustrating an example of a part of a film according to this embodiment.

FIG. 3 is a cross-sectional view illustrating an example of a cross-section taken along a line III-III illustrated in FIG. 2.

FIG. 4 is a cross-sectional view illustrating an example of a cross-section taken along a line III-III illustrated in FIG. 2.

FIG. 5 is a cross-sectional view illustrating an example of a cross-section taken along a line III-III illustrated in FIG. 2.

FIGS. 6(a), 6(b), and 6(c) are plan views illustrating a part of another example of a film.

FIG. 7 is a flowchart illustrating an original film manufacturing step illustrated in FIG. 1.

FIGS. 8(a), 8(b), 8(c), and 8(d) are cross-sectional views illustrating the original film manufacturing step illustrated in FIG. 1.

FIGS. 9(a), 9(b), 9(c), and 9(d) are perspective views illustrating the original film manufacturing step illustrated in FIG. 1.

FIGS. 10(a) and 10(b) are plan views illustrating a removing step illustrated in FIG. 1.

FIG. 11 is a schematic view illustrating a removing device used in a first removing method.

FIG. 12 is a schematic view illustrating a removing device used in a second removing method.

FIG. 13 is a schematic view illustrating a removing device used in a third removing method.

FIG. 14 is a schematic view illustrating a removing device used in a fourth removing method.

FIG. 15 is a schematic view illustrating a removing device used in a fifth removing method.

FIG. 16 is a schematic view illustrating a removing device used in a sixth removing method.

FIG. 17 is a plan view illustrating an example of a part of an original film.

FIG. 18 is a plan view illustrating an example of a part of a film.

FIG. 19 is a plan view illustrating an example of a part of a film.

FIG. 20 is a plan view illustrating an example of a part of a film.

FIG. 21 is a plan view illustrating an example of a part of a film.

FIG. 22(a) is a plan view illustrating an example of an original film, and FIG. 22(b) is a plan view illustrating an example of a film.

FIG. 23 is a plan view illustrating an example of a part of a film.

FIG. 24 is a perspective view illustrating a wound body according to this embodiment.

FIG. 25 is a cross-sectional view illustrating a connection structure according to this embodiment.

FIG. 26 is a flowchart illustrating a method for manufacturing a connection structure according to this embodiment.

FIG. 27 is a flowchart illustrating a film manufacturing step illustrated in FIG. 26.

FIG. 28 is a schematic process diagram illustrating a connection step illustrated in FIG. 26.

FIG. 29 is a plan view illustrating an example of a part of a film.

FIG. 30 is a plan view illustrating an example of a part of a film.

FIG. 31 is a plan view illustrating an example of a part of an original film.

FIG. 32 is a plan view illustrating an example of a part of a film.

### DESCRIPTION OF EMBODIMENTS

Hereinafter, preferred embodiments of the present disclosure will be described in detail with reference to the drawings. Furthermore, in the drawings, the same or corresponding parts are denoted by the same reference numerals, and duplicate explanations are omitted. Further, in the drawings, the dimensional proportions and the like have been appropriately changed to make the explanation easier to understand.

### Film Manufacturing Method

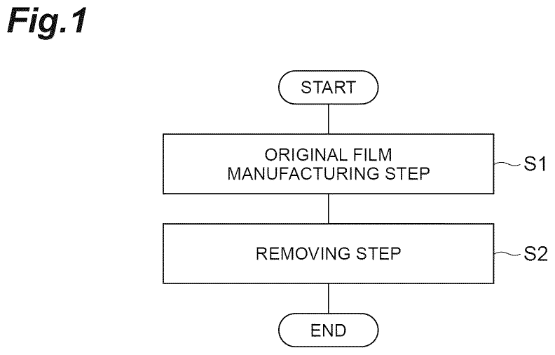

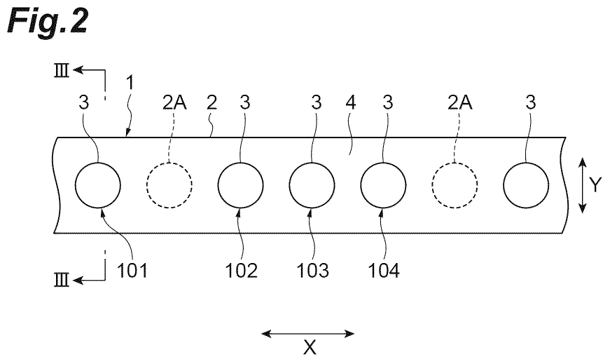

As illustrated in FIGS. 1 and 2, a film manufacturing method is a method for manufacturing a film 1. The film 1 includes a long (tape-like) release film 2, a plurality of adhesive film pieces 3 which are provided on the release film 2 and separated from each other, and a non-adhesive region 4 which is provided on the release film 2 not to have the plurality of adhesive film pieces 3 provided thereon.

### Release Film

The release film 2 is attached to the adhesive film piece 3 and supports the plurality of adhesive film pieces 3. The material of the release film 2 may be, for example, polyethylene terephthalate (PET), polyethylene, polypropylene, or the like. The release film 2 may contain any filler. Further, the surface of the release film 2 may be subjected to a release treatment, a plasma treatment, an antistatic treatment, or the like.

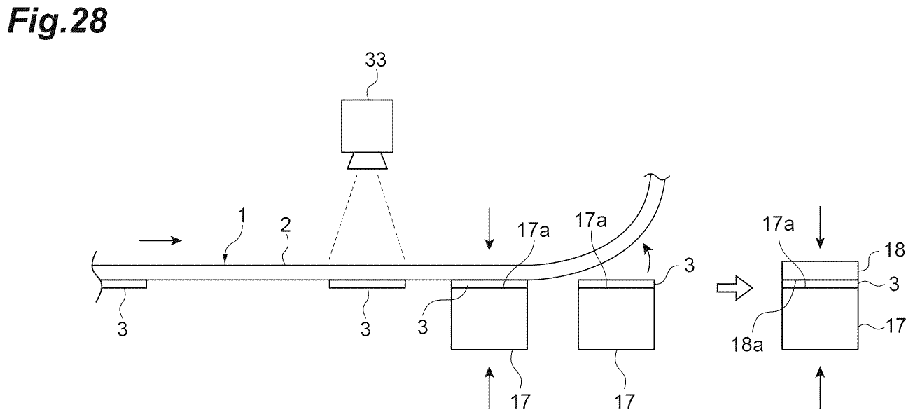

Incidentally, when attaching the adhesive film piece 3 to the attachment surface (not illustrated) of the adhesion target (not illustrated) with high accuracy, it is preferable to specify the position of the adhesive film piece 3 on the film 1. For example, the release film 2 may be provided with an alignment mark for specifying the position of the adhesive film piece 3 on the film 1, and the position of the adhesive film piece 3 may be specified based on this alignment mark. Further, the specific arrangement of the adhesive film piece 3 on the film 1 may be detected to specify the position of the adhesive film piece 3 on the film 1. Therefore, it is conceivable to detect the position of the adhesive film piece 3 on the film 1 using an image capturing device 33 (see FIG. 28). However, when it is conceived that the adhesive film piece 3 is attached to the attachment surface after that, it is preferable to place the image capturing device 33 on the opposite side of the release film 2 to the adhesive film piece 3.

Therefore, the release film 2 may be optically transparent so that the position of the adhesive film piece 3 can be detected from the side of the release film 2 by the image capturing device 33.

In this case, the transmittance of the release film 2 can be from 15% to 100%, preferably from 15% to 99%, and more preferably from 16% to 98%.

The transmittance of the release film 2 can be measured as follows. The release film cut into a 50 mm×50 mm square is placed in a haze meter (for example, NDH-5000 manufactured by NIPPON DENSHOKU INDUSTRIES CO., LTD.) and the total light transmittance is measured. Then, the measurement result is regarded as the transmittance of the release film 2.

Further, the haze value of the release film 2 can be from 3% to 100%, preferably from 3% to 99%, and more preferably from 4% to 99%.

The haze value of the release film 2 can be measured as follows. The release film cut into a 50 mm×50 mm square is placed in a haze meter (for example, NDH-5000 manufactured by NIPPON DENSHOKU INDUSTRIES CO., LTD.) and the haze value is measured. Then, the measurement result is regarded as the haze value of the release film 2.

### Adhesive Film Piece

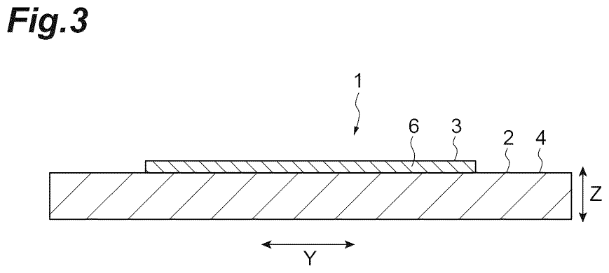

The adhesive film piece 3 connects a first member and a second member which are the adhesion targets. As illustrated in FIGS. 3 to 5, the adhesive film piece 3 includes an adhesive 6 on the film.

The adhesive 6 forming the adhesive film piece 3 may be, for example, a thermoplastic resin, a thermosetting resin, a mixture of a thermoplastic resin and a thermosetting resin, or a photocurable resin. As the thermoplastic resin, for example, a styrene resin or a polyester resin is used. As the thermosetting resin, for example, an epoxy resin or a silicone resin is used. When using thermoplastic or thermosetting resins, heating and pressurizing are usually required. In the case of thermoplastic resins, this is to cause the resin flow and obtain an adhesion force to the adhesion body, and in the case of thermosetting resins, this is to cause a curing reaction of the resin. In addition, since photocurable resins do not require heating for curing, they are useful when connections are required at low temperatures.

Further, as the adhesive 6 forming the adhesive film piece 3, from the viewpoint of minimizing the effect of heat on parts other than the connection part, for example, a resin may be used whose curing degree in differential scanning calorimetry (DSC) is 80% or more at 230° C. for 30 seconds, 80% or more at 210° C. for 30 seconds, 80% or more at 190° C. for 30 seconds, 80% or more at 170° C. for 30 seconds, 80% or more at 150° C. for 30 seconds, 80% or more at 130° C. for 30 seconds, or 80% or more at 100° C. for 30 seconds. These resin properties can be optimized to suit the reliability level required for the final device. The curing degree in differential scanning calorimetry can be measured by a differential scanning calorimeter (for example, DSC Q-1000 manufactured by TA Instruments, Inc.).

The adhesive film piece 3 may be conductive or may not be conductive. For example, the adhesive film piece 3 may be formed of a conductive adhesive film, a non-conductive adhesive film, or a hybrid adhesive film having conductive and non-conductive adhesive regions. Further, the adhesive film piece 3 may be composed of two layers including a first adhesive layer and a second adhesive layer, or may be composed of three or more layers including a first adhesive layer, a second adhesive layer, and a third adhesive layer. The first adhesive layer, the second adhesive layer, and the third adhesive layer may be conductive or may not be conductive.

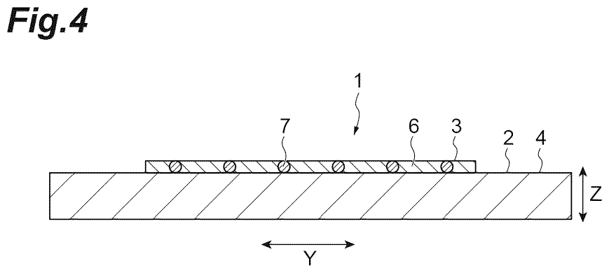

The conductive adhesive film forming the adhesive film piece 3 may have, for example, isotropic conductivity or anisotropic conductivity. For example, as illustrated in FIG. 4, conductive particles 7 are contained in the adhesive 6, for example, to provide anisotropic conductivity. The conductive particles 7 are contained in, for example, the adhesive 6.

The conductive particles 7 may be, for example, metal particles such as Au, Ag, Ni, Cu, Pd, solder, or carbon particles. Further, the conductive particles 7 may be formed of transition metals such as Ni and Cu, the surface of which is coated with a noble metal such as Au, Ag, or Pd. Further, the conductive particles 7 may be non-conductive particles such as glass, ceramic, or plastic with a conductive layer formed on the surface of the non-conductive particles by coating the surface of the non-conductive particles with a conductive material. The conductive particles 7 may further be those in which the outermost layer is formed of a noble metal, those using heat-fusible metal particles, or the like.

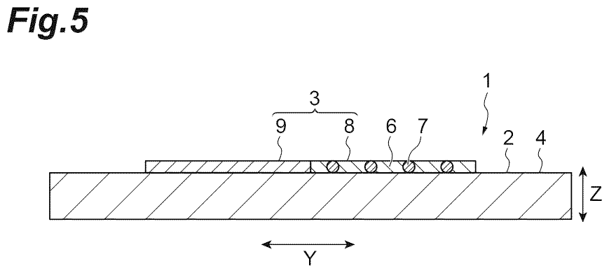

The hybrid adhesive film forming the adhesive film piece 3 may be, for example, one in which a conductive adhesive region 8 and a non-conductive adhesive region 9 are adjacently disposed on the release film 2 as illustrated in FIG. 5. The conductive adhesive region 8 may, for example, contain the conductive particles 7 similar to the conductive adhesive film.

The shape of the adhesive film piece 3 is not particularly limited and may be in various shapes. For example, the shape of the adhesive film piece 3 may be a circle such as a perfect circle or an ellipse, a polygon such as a triangle or a rectangle, a star, or a complex shape such as various marks. Examples of the rectangle include a square, a rectangle, a trapezoid, and the like.

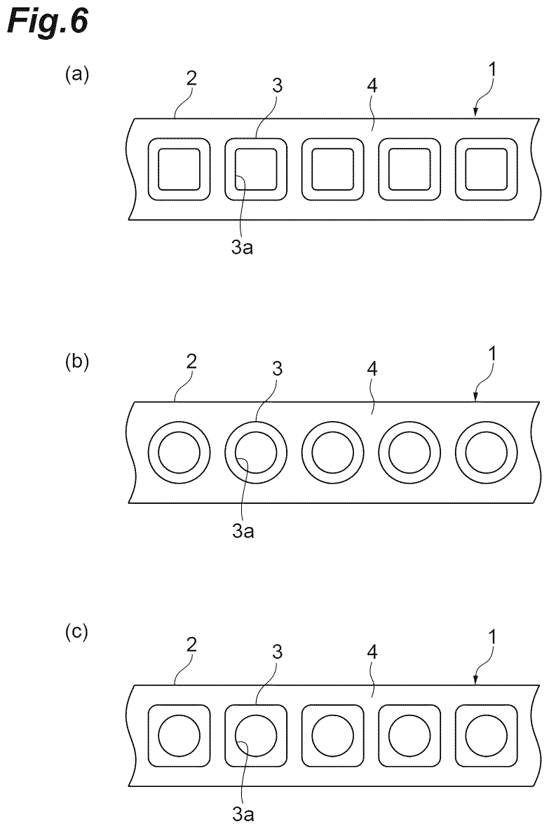

Further, the adhesive film piece 3 may be provided with a hole 3a as illustrated in FIGS. 6(a) to 6(c). The hole 3a is formed by hollowing out (punching out) a part of the adhesive film piece 3. The shape, size, position, number, and the like of the holes 3a are not particularly limited. For example, the hole 3a may or may not have a shape similar to that of the adhesive film piece 3. The shape of the hole 3a may be a circle such as a perfect circle or an ellipse, a polygon such as a triangle or a rectangle, a star, or a complex shape such as various marks. Examples of the rectangle include a square, a rectangle, a trapezoid, and the like. The hole 3a may be located in the center of the adhesive film piece 3 or at an end of the adhesive film piece 3. The number of holes 3a formed in one adhesive film piece 3 may be one or two or more. When a plurality of holes 3a are formed in one adhesive film piece 3, the shapes, sizes, and the like of the holes 3a may be the same or different. The adhesive film piece 3 illustrated in FIG. 6(a) has a rectangular outer shape, and a rectangular hole 3a similar to the outer shape of the adhesive film piece 3 is formed in the center. The adhesive film piece 3 illustrated in FIG. 6(b) has a circular outer shape, and a circular hole 3a similar to the outer shape of the adhesive film piece 3 is formed in the center. The adhesive film piece 3 illustrated in FIG. 6(c) has a rectangular outer shape, and a circular rectangular hole 3a is formed in the center.

Then, the film manufacturing method includes an original film manufacturing step (S1) and a removing step (S2) performed after the original film manufacturing step (S1).

### Original Film Manufacturing Step

In the original film manufacturing step (S1), an original film in which a plurality of adhesive film pieces are provided on a long release film is manufactured.

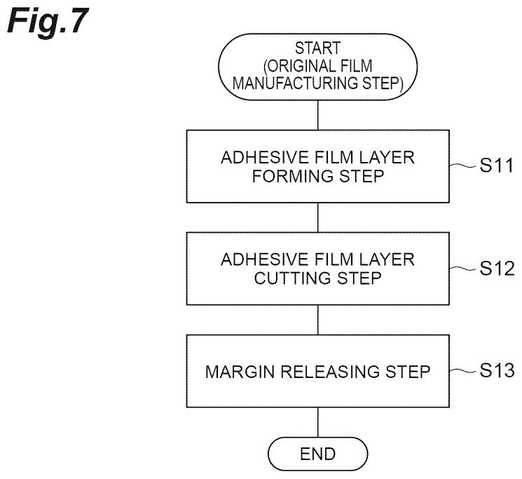

As illustrated in FIGS. 7 to 9, the original film manufacturing step (S1) includes an adhesive film layer forming step (S11), an adhesive film layer cutting step (S12) performed after the adhesive film layer forming step (S11), and a margin releasing step (S13) performed after the adhesive film layer cutting step (S12).

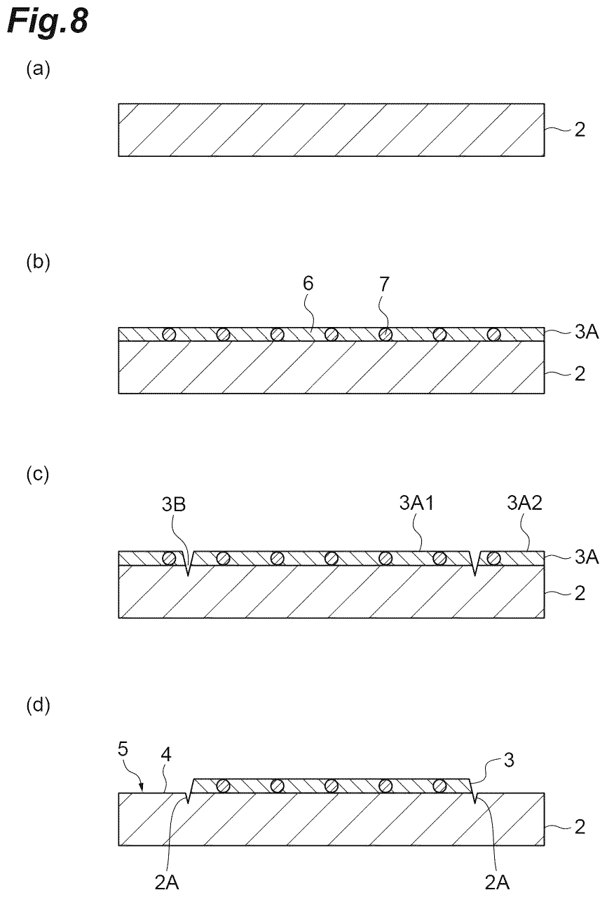

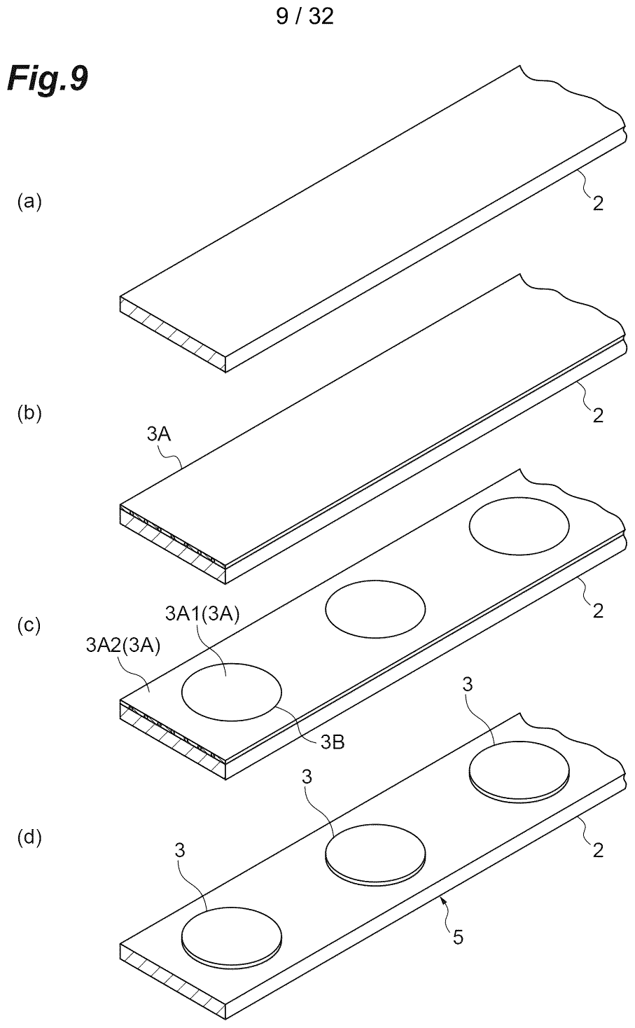

In the adhesive film layer forming step (S11), first, as illustrated in FIGS. 8(a) and 9(a), the release film 2 is prepared. Then, as illustrated in FIGS. 8(b) and 9(b), an adhesive film layer 3A is formed on the entire surface of the release film 2. The adhesive film layer 3A is a layer that will become the plurality of adhesive film pieces 3. The adhesive film layer 3A contains, for example, the adhesive 6 and the conductive particles 7. The adhesive 6 and the conductive particles 7 that form the adhesive film layer 3A are the same as the adhesive 6 and the conductive particles 7 that form the adhesive film piece 3.

In the adhesive film layer cutting step (S12), as illustrated in FIGS. 8(c) and 9(c), the adhesive film layer 3A formed on the release film 2 is cut along an outline 3B that forms the outer shape of the plurality of adhesive film pieces 3 provided on the original film 5. Accordingly, the adhesive film layer 3A is divided into an inner portion 3A1 which is located inside the outline 3B and a plurality of margin portions 3A2 which are located outside the outline 3B. The inner portion 3A1 is a portion that will become the plurality of adhesive film pieces 3 provided on the original film 5. The margin portion 3A2 is a portion that will become a portion other than the plurality of adhesive film pieces 3 provided on the original film 5. The adhesive film layer 3A is cut, for example, by pressing the adhesive film layer 3A against a roll cutter having a cutting blade formed on the outer circumferential surface and half-cutting the release film 2. “Half-cutting the release film 2” means cutting the surface of the release film 2 on the side of the adhesive film layer 3A so that the surface of the release film 2 opposite to the adhesive film layer 3A is not cut. Therefore, notches corresponding to the outer shape of the plurality of adhesive film pieces 3 provided on the original film 5 are formed on the surface of the release film 2 on the side of the adhesive film layer 3A. Accordingly, even when the adhesive film piece 3 has a complex or minute shape, the adhesive film layer 3A can be easily cut along the outline 3B.

In the margin releasing step (S13), as illustrated in FIGS. 8(d) and 9(d), the margin portion 3A2 of the adhesive film layer 3A is released from the release film 2 along the cut outline 3B. The margin portion 3A2 is released, for example, by attaching an adhesive tape to the margin portion 3A2 and pulling the adhesive tape to release the margin portion 3A2 from the release film 2. Then, the inner portion 3A1 remaining on the release film 2 becomes the plurality of adhesive film pieces 3 provided on the original film 5. Accordingly, the original film 5 having the plurality of adhesive film pieces 3 provided on the release film 2 is manufactured.

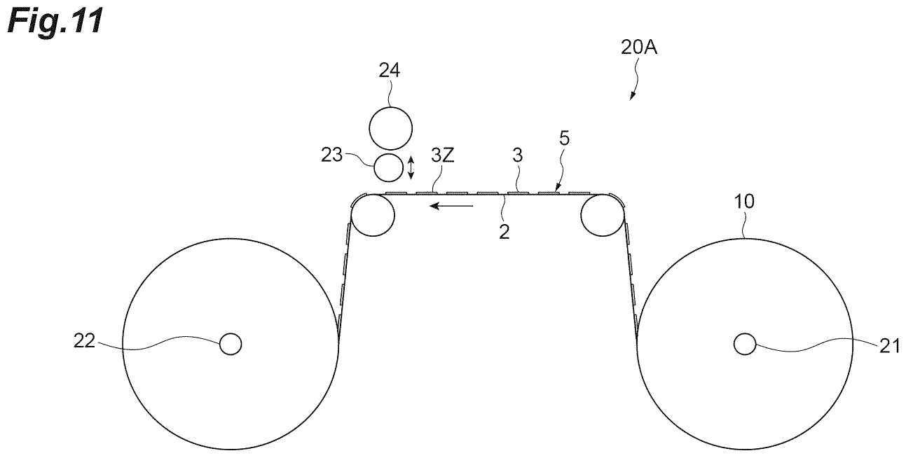

The original film 5 manufactured in this way is stored and transported as a wound body 10 (see FIGS. 11 to 16) wound around a core (not illustrated) and then is passed to the removing step (S2). Furthermore, the original film 5 may also be passed to the removing step (S2) without being wound as the wound body 10.

### Removing Step

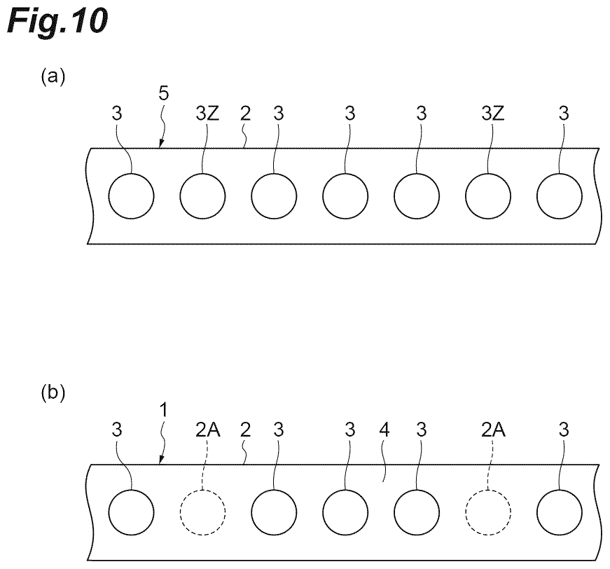

As illustrated in FIGS. 10(a) and 10(b), in the removing step (S2), at least one removal target adhesive film piece 3Z of the plurality of adhesive film pieces 3 is removed from the original film 5. Accordingly, the film 1 is manufactured. In the film 1, a half cut 2A corresponding to the outer shape of the removal target adhesive film piece 3Z is formed in the non-adhesive region 4 of the release film 2 as a removed trace of the removal target adhesive film piece 3Z.

To determine the adhesive film piece 3 as the removal target adhesive film piece among the plurality of adhesive film pieces 3 provided on the original film 5 is not particularly limited. For example, among the plurality of adhesive film pieces 3 provided on the original film 5, the adhesive film piece 3 at a different position from the attachment surface (not illustrated) of the adhesion target (not illustrated) may be determined as the removal target adhesive film piece. Further, among the plurality of adhesive film pieces 3 provided on the original film 5, the defective adhesive film piece 3 may be the removal target adhesive film piece.

The method for removing the removal target adhesive film piece 3Z from the original film 5 is not particularly limited, but for example, there is a roller removing method using a roller or a tape removing method using a tape.

Further, the removal target adhesive film piece may be manually or automatically removed from the original film 5. When automatically removing the removal target adhesive film piece from the original film 5, for example, a detection step of detecting the removal target adhesive film piece may be performed, and in the removing step (S2), the removal target adhesive film piece detected by the detection step may be removed from the original film 5.

Here, as examples of the method for removing the removal target adhesive film piece 3Z from the original film 5, the following six removing methods will be described.

### First Removing Method

In the first removing method, the removal target adhesive film piece 3Z is removed from the original film 5 by using a removing device 20A illustrated in FIG. 11. The removing device 20A includes an unwinding shaft on which a wound body formed by winding an original film, having a plurality of adhesive film pieces provided on a long release film, thereon is set, a winding shaft which winds up the original film unwound from the wound body, a first adhesion roller to which at least one removal target adhesive film piece of the plurality of adhesive film pieces is transferred from the original film, a second adhesion roller to which the removal target adhesive film piece transferred to the first adhesion roller is transferred by contacting or approaching the first adhesion roller, and a drive mechanism which moves the first adhesion roller to be able to contact and separate from the original film reaching the winding shaft from the unwinding shaft.

The removing device 20A illustrated in FIG. 11 includes an unwinding shaft 21, a winding shaft 22, a first adhesion roller 23, and a second adhesion roller 24. The unwinding shaft 21 is a rotatable shaft on which the wound body 10 formed by winding the original film 5 thereon is set. The winding shaft 22 is a rotatable shaft which winds up the original film 5 unwound from the wound body 10. At least one of the unwinding shaft 21 and the winding shaft 22 is rotationally driven by a rotation drive device (not illustrated) such as a motor. The first adhesion roller 23 is a rotatable adhesion body onto which the removal target adhesive film piece 3Z is transferred from the original film 5. The first adhesion roller 23 is able to contact and separate from the original film 5. That is, the first adhesion roller 23 is able to contact and separate from the transportation path of the original film 5 from when the original film is unwound from the wound body 10 set on the unwinding shaft 21 to when the original film is wound on the winding shaft 22. Furthermore, the first adhesion roller 23 is moved by a drive mechanism (not illustrated) to be able to contact and separate from the original film 5. The driving of the drive mechanism is controlled by, for example, a control device (not illustrated). The second adhesion roller 24 is an adhesion body to which the removal target adhesive film piece 3Z transferred to the first adhesion roller 23 is transferred by contacting or approaching the first adhesion roller 23. The second adhesion roller 24 is disposed not to contact the original film 5. The second adhesion roller 24 may be movable in a direction of contacting and separating from the original film 5 by a drive mechanism (not illustrated) while being integrated with the first adhesion roller 23 or independent from the first adhesion roller 23.

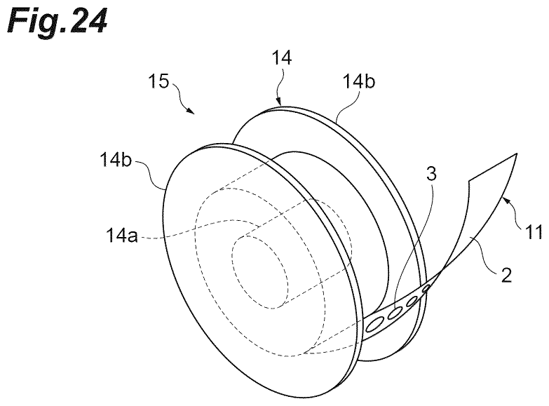

Then, in the first removing method, the wound body 10 formed by winding the original film 5 thereon is set on the unwinding shaft 21, and a core 14 (see FIG. 24) for winding the film 1 thereon is set on the winding shaft 22. Then, the unwinding shaft 21 and the winding shaft 22 are rotated so that the original film 5 unwound from the wound body 11 is wound on the core 14 set on the winding shaft 22. At this time, the first adhesion roller 23 is separated from the original film 5, and when the removal target adhesive film piece 3Z reaches, the first adhesion roller 23 is moved close to the original film 5 to contact the removal target adhesive film piece 3Z. Accordingly, the removal target adhesive film piece 3Z is transferred from the original film 5 to the first adhesion roller 23. Then, when the removal target adhesive film piece 3Z is transferred to the first adhesion roller 23, the first adhesion roller 23 is separated from the original film 5. Accordingly, the removal target adhesive film piece 3Z is removed from the original film 5. Further, the removal target adhesive film piece 3Z transferred to the first adhesion roller 23 is transferred from the first adhesion roller 23 to the second adhesion roller 24.

### Second Removing Method

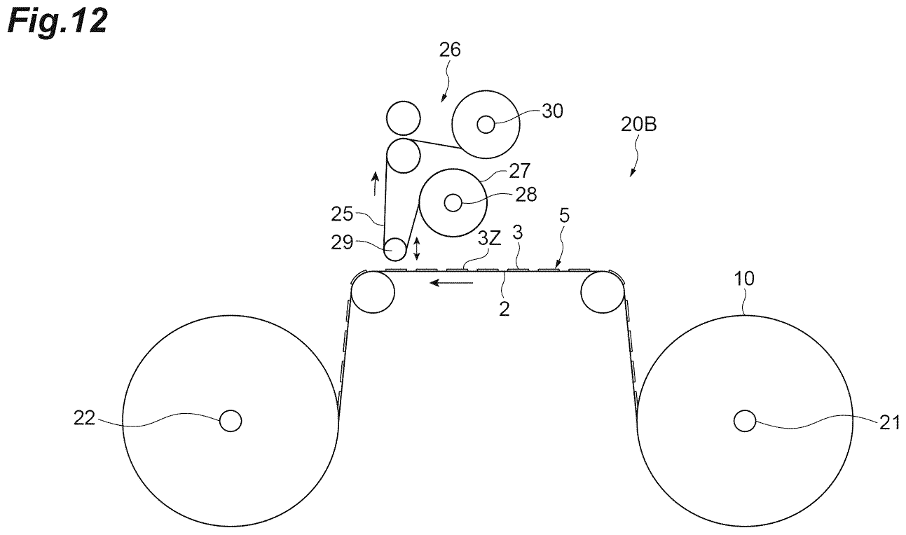

In the second removing method, the removal target adhesive film piece 3Z is removed from the original film 5 by using a removing device 20B illustrated in FIG. 12. The removing device 20B includes an unwinding shaft on which a wound body, formed by winding an original film having a plurality of adhesive film pieces provided on a long release film, is set, a winding shaft which winds up the original film unwound from the wound body, an adhesion tape to which at least one removal target adhesive film piece of the plurality of adhesive film pieces is transferred from the original film, and a drive mechanism which moves the adhesion tape to be able to contact and separate from the original film reaching the winding shaft from the unwinding shaft.

The removing device 20B illustrated in FIG. 12 is basically the same as the removing device 20A illustrated in FIG. 11, but is different from the removing device 20A illustrated in FIG. 11 in that the adhesion tape is provided instead of the first adhesion roller and the second adhesion roller. Therefore, only the different points from the removing device 20A illustrated in FIG. 11 will be described, and the description of the same points as the removing device 20A illustrated in FIG. 11 will be omitted.

The removing device 20B illustrated in FIG. 12 includes an unwinding shaft 21, a winding shaft 22, and an adhesion tape 25. The adhesion tape 25 is a tape-like adhesion body to which the removal target adhesive film piece 3Z is transferred from the original film 5. The adhesion tape 25 is able to contact and separate from the original film 5. That is, the adhesion tape 25 is able to contact and separate from the transportation path of the original film 5 from when the original film is unwound from the wound body 10 set on the unwinding shaft 21 to when the original film is wound on the winding shaft 22. Furthermore, the adhesion tape 25 is moved by a drive mechanism (not illustrated) to be able to contact and separate from the original film 5. The driving of the drive mechanism is controlled by, for example, a control device (not illustrated). Further, the adhesion tape 25 is transported by a tape transportation mechanism 26. The tape transportation mechanism 26 transports the adhesion tape 25 so that a new surface of the adhesion tape 25 always contacts the original film 5. The tape transportation mechanism 26 includes, for example, an unwinding shaft 28 on which a wound body 27 of the adhesion tape 25 is set and which feeds out the adhesion tape 25 from the wound body 27, a pressure roller 29 which presses the adhesion tape 25 unwound from the wound body 27 against the original film 5, and a winding shaft 30 which winds up the adhesion tape 25 unwound from the wound body 27.

Then, in the second removing method, the wound body 10 formed by winding the original film 5 thereon is set on the unwinding shaft 21, and the core 14 for winding the film 1 thereon is set on the winding shaft 22. Then, the unwinding shaft 21 and the winding shaft 22 are rotated so that the original film 5 unwound from the wound body 11 is wound on the core 14 set on the winding shaft 22. At this time, the adhesion tape 25 is separated from the original film 5, and when the removal target adhesive film piece 3Z reaches, the adhesion tape 25 is moved close to the original film 5 to contact the removal target adhesive film piece 3Z. Accordingly, the removal target adhesive film piece 3Z is transferred from the original film 5 to the adhesion tape 25. Then, when the removal target adhesive film piece 3Z is transferred to the adhesion tape 25, the adhesion tape 25 is separated from the original film 5. Accordingly, the removal target adhesive film piece 3Z is removed from the original film 5. Then, the adhesion tape 25 is transported by the tape transportation mechanism 26 so that a new surface of the adhesion tape 25 can contact the next reaching removal target adhesive film piece 3Z.

### Third Removing Method

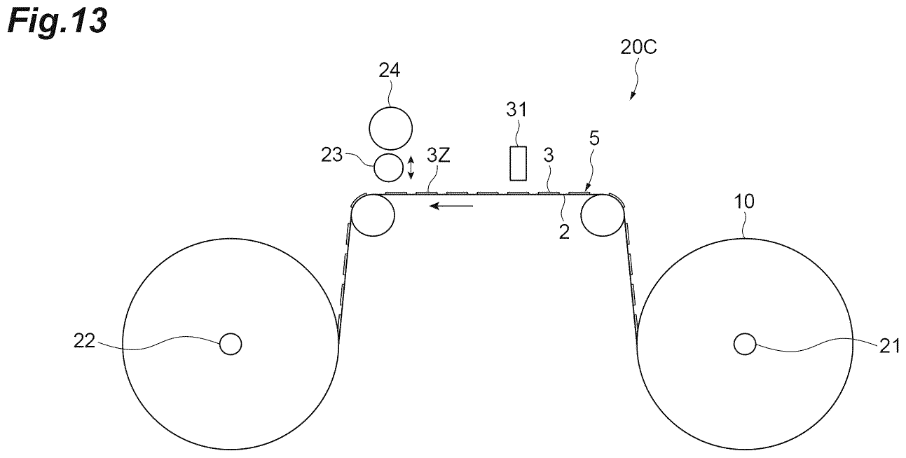

In the third removing method, the removal target adhesive film piece 3Z is removed from the original film 5 by using a removing device 20C illustrated in FIG. 13. The removing device 20C has a configuration in which the removing device 20A further includes a sensor which detects an adhesive film piece at a predetermined position among the plurality of adhesive film pieces as the removal target adhesive film piece. The drive mechanism moves the first adhesion roller close to the original film so that the first adhesion roller contacts the removal target adhesive film at a timing at which the removal target adhesive film piece detected by the sensor reaches.

The removing device 20C illustrated in FIG. 13 is basically the same as the removing device 20A illustrated in FIG. 11, but is different from the removing device 20A illustrated in FIG. 11 in that the sensor is further provided. Therefore, only the different points from the removing device 20A illustrated in FIG. 11 will be described below, and the description of the same points as the removing device 20A illustrated in FIG. 11 will be omitted.

The removing device 20C illustrated in FIG. 13 includes the unwinding shaft 21, the winding shaft 22, the first adhesion roller 23, the second adhesion roller 24, and a sensor 31. The sensor 31 detects the adhesive film piece at a predetermined position among the plurality of adhesive film pieces 3 as the removal target adhesive film piece 3Z.

The predetermined position is, for example, a position that is an appropriate combination of a position of the release film 2 in the longitudinal direction X and a position of the release film 2 in the width direction Y. The longitudinal direction X of the release film 2 is a direction in which the release film 2 extends and a direction in which the film is wound on the core 14. The width direction Y of the release film 2 is a direction that is orthogonal to the longitudinal direction X of the release film 2 and the thickness direction Z of the release film 2 (see FIGS. 3 to 5). The predetermined position may be one or more. When there are a plurality of predetermined positions, the predetermined positions may be positions that are separated at a predetermined interval in the longitudinal direction X of the release film 2 or the width direction Y of the release film 2, or may be positions that are not separated at a predetermined interval in the longitudinal direction X of the release film 2 or the width direction Y of the release film 2.

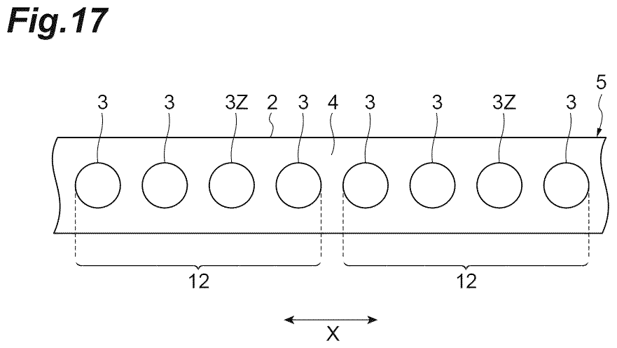

For example, as illustrated in FIG. 17, the predetermined position may be the same position among a plurality of adhesive film piece groups 12 when the plurality of adhesive film pieces 3 on the original film 5 are divided into the plurality of adhesive film piece groups 12 arranged in the longitudinal direction X of the release film 2. That is, the adhesive film piece at the same position of the plurality of adhesive film piece groups may be detected as the removal target adhesive film piece 3Z. Furthermore, the predetermined position may not be the same position among the plurality of adhesive film piece groups 12.

Then, in the third removing method, the wound body 10 formed by winding the original film 5 thereon is set on the unwinding shaft 21, and the core 14 for winding the film 1 thereon is set on the winding shaft 22. Then, the unwinding shaft 21 and the winding shaft 22 are rotated so that the original film 5 unwound from the wound body 11 is wound on the core 14 set on the winding shaft 22. At this time, the first adhesion roller 23 is separated from the original film 5. Then, when the sensor 31 detects the adhesive film piece at a predetermined position among the plurality of adhesive film pieces 3 as the removal target adhesive film piece 3Z, the first adhesion roller 23 is moved close to the original film 5 to contact the removal target adhesive film piece 3Z at a timing at which the detected removal target adhesive film piece 3Z reaches. Accordingly, the removal target adhesive film piece 3Z is transferred from the original film 5 to the first adhesion roller 23. Then, when the removal target adhesive film piece 3Z is transferred to the first adhesion roller 23 the first adhesion roller 23 is separated from the original film 5. Accordingly, the removal target adhesive film piece 3Z is removed from the original film 5. Further, the removal target adhesive film piece 3Z transferred to the first adhesion roller 23 is transferred from the first adhesion roller 23 to the second adhesion roller 24.

### Fourth Removing Method

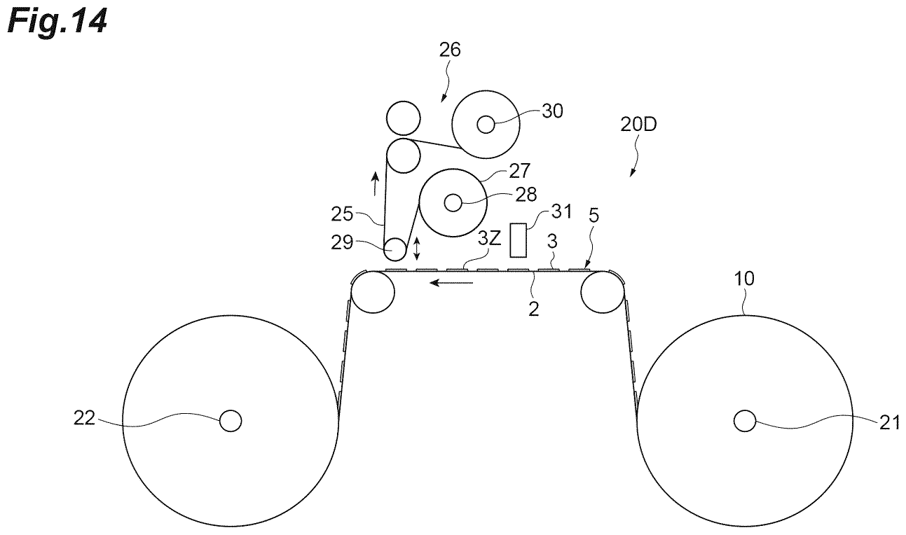

In the fourth removing method, the removal target adhesive film piece 3Z is removed from the original film 5 by using a removing device 20D illustrated in FIG. 14. The removing device 20D has a configuration in which the removing device 20B further includes a sensor which detects an adhesive film piece at a predetermined position among the plurality of adhesive film pieces as the removal target adhesive film piece. The drive mechanism moves the adhesion tape close to the original film so that the adhesion tape contacts the removal target adhesive film at a timing at which the removal target adhesive film piece detected by the sensor reaches.

The removing device 20D illustrated in FIG. 14 is basically the same as the removing device 20B illustrated in FIG. 12, but is different from the removing device 20B illustrated in FIG. 12 in that the sensor is further provided. Therefore, only the different points from the removing device 20B illustrated in FIG. 12 will be described below, and the description of the same points as the removing device 20B illustrated in FIG. 12 will be omitted.

The removing device 20D illustrated in FIG. 14 includes the unwinding shaft 21, the winding shaft 22, the adhesion tape 25, and the sensor 31. The sensor 31 is the same as that of the removing device 20C illustrated in FIG. 13, and is configured to detect the adhesive film piece at a predetermined position among the plurality of adhesive film pieces 3 as the removal target adhesive film piece 3Z.

Then, in the fourth removing method, the wound body 10 formed by winding the original film 5 thereon is set on the unwinding shaft 21, and the core 14 for winding the film 1 thereon is set on the winding shaft 22. Then, the unwinding shaft 21 and the winding shaft 22 are rotated so that the original film 5 unwound from the wound body 11 is wound on the core 14 set on the winding shaft 22. At this time, the adhesion tape 25 is separated from the original film 5. Then, when the sensor 31 detects the adhesive film piece at a predetermined position among the plurality of adhesive film pieces 3 as the removal target adhesive film piece 3Z, the adhesion tape 25 is moved close to the original film 5 to contact the removal target adhesive film piece 3Z at a timing at which the detected removal target adhesive film piece 3Z reaches. Accordingly, the removal target adhesive film piece 3Z is transferred from the original film 5 to the adhesion tape 25. Then, when the removal target adhesive film piece 3Z is transferred to the adhesion tape 25, the adhesion tape 25 is separated from the original film 5. Accordingly, the removal target adhesive film piece 3Z is removed from the original film 5. Then, the adhesion tape 25 is transported by the tape transportation mechanism 26 so that a new surface of the adhesion tape 25 contacts the next reaching removal target adhesive film piece 3Z.

### Fifth Removing Method

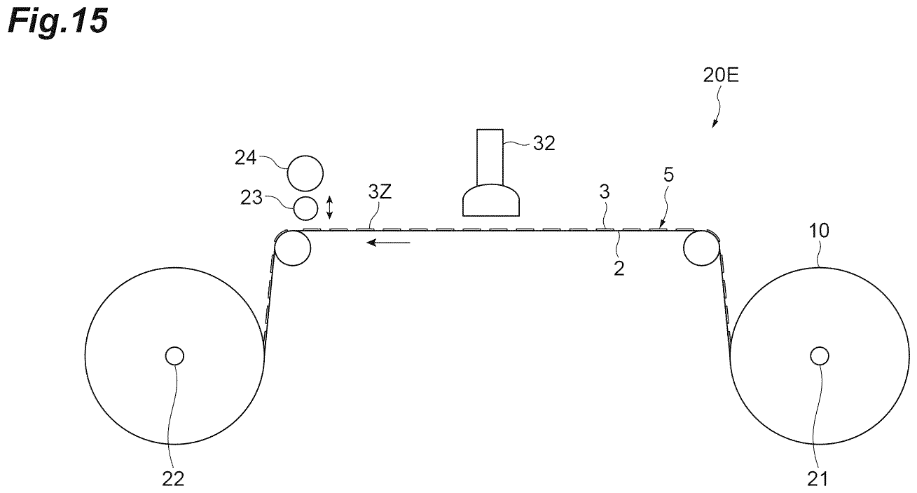

In the fifth removing method, the removal target adhesive film piece 3Z is removed from the original film 5 by using a removing device 20E illustrated in FIG. 15. The removing device 20E has a configuration in which the removing device 20A further includes an inspection machine that inspects the plurality of adhesive film pieces provided on the original film and detects the adhesive film piece determined to be defective as the removal target adhesive film piece. The drive mechanism moves the first adhesion roller close to the original film so that the first adhesion roller contacts the removal target adhesive film piece at a timing at which the removal target adhesive film piece detected by the inspection machine reaches.

The removing device 20E illustrated in FIG. 15 is basically the same as the removing device 20A illustrated in FIG. 11, but is different from the removing device 20A illustrated in FIG. 11 in that the inspection machine is further provided. Therefore, only the different points from the removing device 20A illustrated in FIG. 11 will be described below, and the description of the same points as the removing device 20A illustrated in FIG. 11 will be omitted.

The removing device 20E illustrated in FIG. 15 includes the unwinding shaft 21, the winding shaft 22, the first adhesion roller 23, the second adhesion roller 24, and an inspection machine 32. The inspection machine 32 inspects the plurality of adhesive film pieces 3 provided on the original film 5. The inspection machine 32 determines whether the adhesive film piece 3 is non-defective or defective based on, for example, the shape, position, size, and the like of the adhesive film piece 3. Then, the inspection machine 32 detects the adhesive film piece 3 determined to be defective as the removal target adhesive film piece 3Z.

Then, in the fifth removing method, the wound body 10 formed by winding the original film 5 thereon is set on the unwinding shaft 21, and the core 14 for winding the film 1 thereon is set on the winding shaft 22. Then, the unwinding shaft 21 and the winding shaft 22 are rotated so that the original film 5 unwound from the wound body 11 is wound on the core 14 set on the winding shaft 22. At this time, the first adhesion roller 23 is separated from the original film 5. Then, when the adhesive film piece 3 determined to be defective by the inspection machine 32 is detected as the removal target adhesive film piece 3Z, the first adhesion roller 23 is moved close to the original film 5 to contact the removal target adhesive film piece 3Z at a timing at which the detected removal target adhesive film piece 3Z reaches. Accordingly, the removal target adhesive film piece 3Z is transferred from the original film 5 to the first adhesion roller 23. Then, when the removal target adhesive film piece 3Z is transferred to the first adhesion roller 23 the first adhesion roller 23 is separated from the original film 5. Accordingly, the removal target adhesive film piece 3Z is removed from the original film 5. Further, the removal target adhesive film piece 3Z transferred to the first adhesion roller 23 is transferred from the first adhesion roller 23 to the second adhesion roller 24.

### Sixth Removing Method

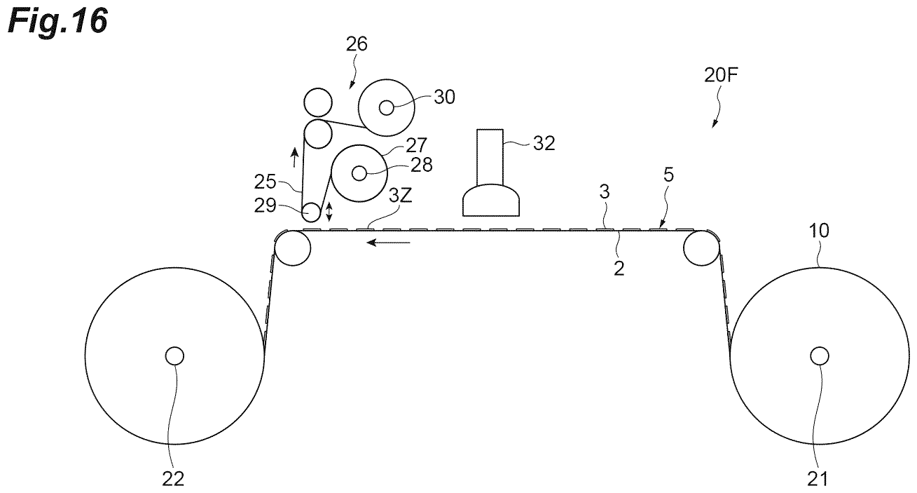

In the sixth removing method, the removal target adhesive film piece 3Z is removed from the original film 5 by using a removing device 20F illustrated in FIG. 16. The removing device 20F has a configuration in which the removing device 20B further includes an inspection machine that inspects the plurality of adhesive film pieces provided on the original film and detects the adhesive film piece determined to be defective as the removal target adhesive film piece. The drive mechanism moves the adhesion tape close to the original film so that the adhesion tape contacts the removal target adhesive film piece at a timing at which the removal target adhesive film piece detected by the inspection machine reaches.

The removing device 20F illustrated in FIG. 16 is basically the same as the removing device 20B illustrated in FIG. 12, but is different from the removing device 20B illustrated in FIG. 12 in that the inspection machine is further provided. Therefore, only the different points from the removing device 20B illustrated in FIG. 12 will be described below, and the description of the same points as the removing device 20B illustrated in FIG. 12 will be omitted.

The removing device 20F illustrated in FIG. 16 includes the unwinding shaft 21, the winding shaft 22, the adhesion tape 25, and the inspection machine 32. The inspection machine 32 is the same as that of the removing device 20E illustrated in FIG. 15, and is configured to inspect the plurality of adhesive film pieces 3 provided on the original film 5 and detect the adhesive film piece determined to be defective as the removal target adhesive film piece 3Z.

Then, in the sixth removing method, the wound body 10 formed by winding the original film 5 thereon is set on the unwinding shaft 21, and the core 14 for winding the film 1 thereon is set on the winding shaft 22. Then, the unwinding shaft 21 and the winding shaft 22 are rotated so that the original film 5 unwound from the wound body 11 is wound on the core 14 set on the winding shaft 22. At this time, the adhesion tape 25 is separated from the original film 5. Then, when the adhesive film piece 3 determined to be defective by the inspection machine 32 is detected as the removal target adhesive film piece 3Z, the adhesion tape 25 is moved close to the original film 5 to contact the removal target adhesive film piece 3Z at a timing at which the detected removal target adhesive film piece 3Z reaches. Accordingly, the removal target adhesive film piece 3Z is transferred from the original film 5 to the adhesion tape 25. Then, when the removal target adhesive film piece 3Z is transferred to the adhesion tape 25, the adhesion tape 25 is separated from the original film 5. Accordingly, the removal target adhesive film piece 3Z is removed from the original film 5. Then, the adhesion tape 25 is transported by the tape transportation mechanism 26 so that a new surface of the adhesion tape 25 contacts the next reaching removal target adhesive film piece 3Z.

### Film

As illustrated in FIGS. 2 to 5, the film 1 includes the long (tape-like) release film 2, the plurality of adhesive film pieces 3 which are provided on the release film 2 and separated from each other, and the non-adhesive region 4 which is provided on the release film 2 not to have the plurality of adhesive film pieces 3 provided thereon. The plurality of adhesive film pieces 3 are provided at least along the longitudinal direction X of the release film 2. Furthermore, the outer shape of the film 1 is defined by the outer shape of the release film 2 in plan view. The film 1 is manufactured, for example, by the above-described film manufacturing method.

The plurality of adhesive film pieces 3 include a first adhesive film piece 101 and a second adhesive film piece 102 which are adjacent to each other through the non-adhesive region 4 and a third adhesive film piece 103 and a fourth adhesive film piece 104 which are adjacent to each other through the non-adhesive region 4. Then, the separation distance between the first adhesive film piece 101 and the second adhesive film piece 102 and the separation distance between the third adhesive film piece 103 and the fourth adhesive film piece 104 are different from each other. That is, the plurality of adhesive film pieces 3 include at least two sets of adhesive film pieces 3 that are separated from each other through the non-adhesive region 4 and have different separation distances.

The first adhesive film piece 101, the second adhesive film piece 102, the third adhesive film piece 103, and the fourth adhesive film piece 104 are the adhesive film pieces 3 among the plurality of adhesive film pieces 3. The plurality of adhesive film pieces 3 may include only one adhesive film piece among the first adhesive film piece 101, the second adhesive film piece 102, the third adhesive film piece 103, and the fourth adhesive film piece 104, or may include a plurality of adhesive film pieces among the first adhesive film piece 101, the second adhesive film piece 102, the third adhesive film piece 103, and the fourth adhesive film piece 104. Further, all of the plurality of adhesive film pieces 3 may be any one of the first adhesive film piece 101, the second adhesive film piece 102, the third adhesive film piece 103, and the fourth adhesive film piece 104. Further, any one of the first adhesive film piece 101 and the second adhesive film piece 102 may be the same adhesive film piece 3 as the third adhesive film piece 103 or the fourth adhesive film piece 104. Similarly, any one of the third adhesive film piece 103 and the fourth adhesive film piece 104 may be the same adhesive film piece 3 as the first adhesive film piece 101 or the second adhesive film piece 102.

The direction in which the first adhesive film piece 101 and the second adhesive film piece 102 are adjacent to each other and the direction in which the third adhesive film piece 103 and the fourth adhesive film piece 104 are adjacent to each other are not particularly limited.

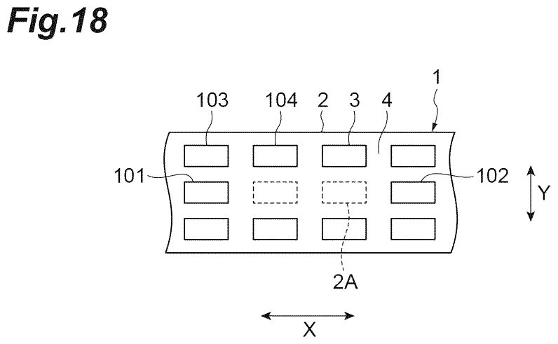

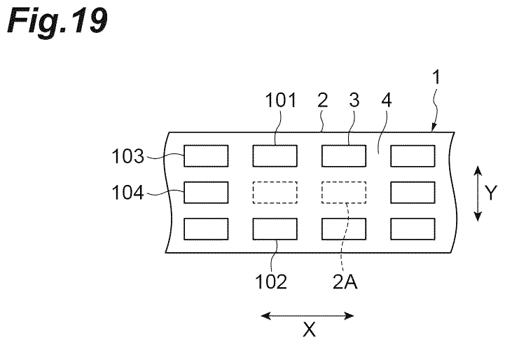

For example, since the plurality of adhesive film pieces 3 are provided along the longitudinal direction X of the release film 2, as illustrated in FIG. 18, the first adhesive film piece 101 and the second adhesive film piece 102 may be adjacent to each other in the longitudinal direction X of the release film 2, and the third adhesive film piece 103 and the fourth adhesive film piece 104 may be adjacent to each other in the longitudinal direction X of the release film 2. Further, for example, when the plurality of adhesive film pieces 3 are arranged in the width direction Y of the release film 2, as illustrated in FIG. 19, the first adhesive film piece 101 and the second adhesive film piece 102 may be adjacent to each other in the width direction Y of the release film 2, and the third adhesive film piece 103 and the fourth adhesive film piece 104 may be adjacent to each other in the width direction Y of the release film 2.

Further, the non-adhesive region 4 may have a first region in which the separation distance between the adjacent adhesive film pieces 3 is longer than the adhesive film piece 3. Furthermore, the non-adhesive region 4 may have a second region in which the separation distance between the adjacent adhesive film pieces 3 is shorter than the adhesive film piece 3. Furthermore, the non-adhesive region 4 may have a third region in which the separation distance between the adjacent adhesive film pieces 3 is shorter than the separation distance between the adjacent adhesive film pieces 3 in the first region. The separation distance in the first region is the separation distance between the adjacent adhesive film pieces 3 that is longer than the adhesive film piece 3 in the first region. “Longer or shorter than the adhesive film piece 3” means, for example, that the length is longer or shorter than the maximum length of the plurality of adhesive film pieces 3. When all of the plurality of adhesive film pieces 3 have the same shape, this means that the length is longer or shorter than the maximum length of any one of the adhesive film pieces 3. For example, when the separation distance between the first adhesive film piece 101 and the second adhesive film piece 102 is longer than the separation distance between the third adhesive film piece 103 and the fourth adhesive film piece 104, the separation distance between the first adhesive film piece 101 and the second adhesive film piece 102 is longer than the maximum length of the first adhesive film piece 101 and the second adhesive film piece 102, and the separation distance between the third adhesive film piece 103 and the fourth adhesive film piece 104 is shorter than the maximum length of the third adhesive film piece 103 and the fourth adhesive film piece 104.

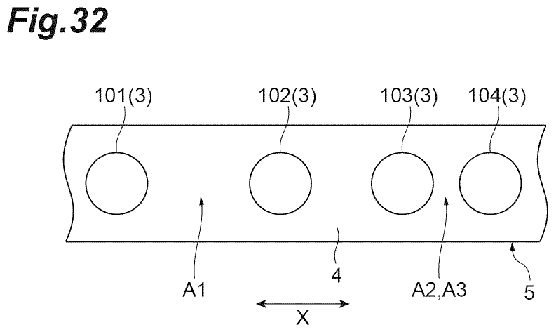

For example, as illustrated in FIG. 32, the non-adhesive region 4 may have a first region A1 in which the separation distance between the first adhesive film piece 101 and the second adhesive film piece 102 adjacent to each other is longer than the adhesive film piece 3. Further, the non-adhesive region 4 may have a second region A2 in which the separation distance between the third adhesive film piece 103 and the fourth adhesive film piece 104 adjacent to each other is shorter than the adhesive film piece 3. Further, the non-adhesive region 4 may have a third region A3 in which the separation distance between the first adhesive film piece 101 and the second adhesive film piece 102 adjacent to each other is shorter than the separation distance between the first adhesive film piece 101 and the second adhesive film piece 102 adjacent to each other in the first region A1.

Further, as illustrated in FIG. 18, the separation distance between the first adhesive film piece 101 and the second adhesive film piece 102 may be longer than the maximum length of the first adhesive film piece 101 and the second adhesive film piece 102 in the direction in which the first adhesive film piece 101 and the second adhesive film piece 102 are separated from each other. The maximum length of the first adhesive film piece 101 and the second adhesive film piece 102 means any one of the maximum length of the first adhesive film piece 101 and the maximum length of the second adhesive film piece 102. Further, when all of the plurality of adhesive film pieces 3 have the same shape, the maximum length of the first adhesive film piece 101 and the second adhesive film piece 102 is also the maximum length of any one adhesive film piece 3. Furthermore, the separation distance between the third adhesive film piece 103 and the fourth adhesive film piece 104 may be shorter than the maximum length of the third adhesive film piece 103 and the fourth adhesive film piece 104 in the direction in which the third adhesive film piece 103 and the fourth adhesive film piece 104 are separated from each other. Furthermore, the separation distance between the third adhesive film piece 103 and the fourth adhesive film piece 104 may be shorter than the separation distance between the first adhesive film piece 101 and the second adhesive film piece 102.

The film 1 may further include the half cut 2A formed in the release film 2. The half cut 2A means that the surface on the side of the adhesive film piece 3 in the release film 2 is cut without cutting the surface opposite to the adhesive film piece 3 in the release film 2. The shape of the half cut 2A is not particularly limited and may be a circle such as a perfect circle or an ellipse, a polygon such as a triangle or a rectangle, a star, or a complex shape such as various marks as in the adhesive film piece 3. Examples of the rectangle include a square, a rectangle, a trapezoid, and the like. When the plurality of adhesive film pieces 3 have the same shape, the half cut 2A may have the same shape as the outer shape of the adhesive film piece 3.

Then, when the separation distance between the first adhesive film piece 101 and the second adhesive film piece 102 in the direction in which the first adhesive film piece 101 and the second adhesive film piece 102 are separated from each other is longer than the maximum length of the adhesive film piece 3, the half cut 2A may be formed in the non-adhesive region 4 between the first adhesive film piece 101 and the second adhesive film piece 102. In this case, the outer shape of the half cut 2A may be the same as the outer shape of the first adhesive film piece 101 or the second adhesive film piece 102. Furthermore, when the plurality of adhesive film pieces 3 include the plurality of first adhesive film pieces 101 and the plurality of second adhesive film pieces 102, the half cut 2A may be formed in the non-adhesive region 4 between all of the first adhesive film pieces 101 and the second adhesive film pieces 102 or the half cut 2A may be formed only in the non-adhesive region 4 between a part of the first adhesive film pieces 101 and the second adhesive film pieces 102.

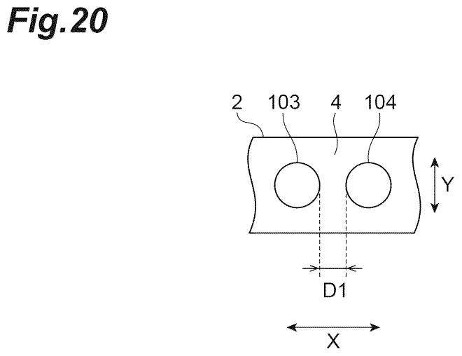

As illustrated in FIG. 20, the separation distance between the third adhesive film piece 103 and the fourth adhesive film piece 104 in the longitudinal direction X when the third adhesive film piece 103 and the fourth adhesive film piece 104 are adjacent to each other in the longitudinal direction X of the release film 2 is defined as a separation distance D1. In this case, from the viewpoint of shortening the transportation distance of the film 1 when attaching the third adhesive film piece 103 and the fourth adhesive film piece 104 and effectively using the film 1 to decrease cost, the separation distance D1 is preferably 20 mm or less, more preferably 10 mm or less, and further preferably 8 mm or less. On the other hand, from the viewpoint of improving the workability in attaching the adhesive film piece 3, the separation distance D1 is preferably 0.1 mm or more, more preferably 0.5 mm or more, and further preferably 1 mm or more. These upper and lower limits can be combined appropriately. For example, the separation distance D1 is preferably 0.1 mm or more and 20 mm or less, more preferably 0.5 mm or more and 10 mm or less, and further preferably 1 mm or more and 8 mm or less.

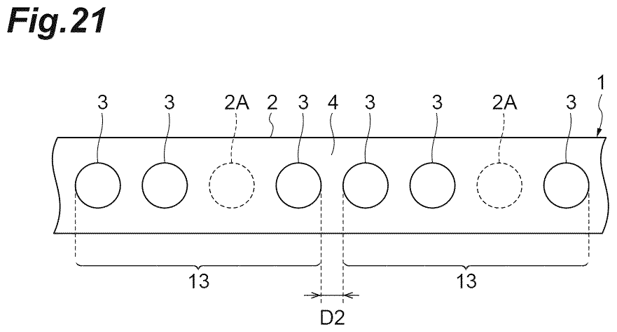

As illustrated in FIG. 21, when the plurality of adhesive film pieces 3 form a plurality of adhesive film piece groups 13 arranged in the longitudinal direction X of the release film 2, the arrangement of the adhesive film pieces 3 may be the same as that of the plurality of adhesive film piece groups 13. That is, each adhesive film piece group 13 is composed of a part of the plurality of adhesive film pieces 3. Then, the adhesive film pieces 3 are arranged in the same manner among the plurality of adhesive film piece groups 13. The length of one adhesive film piece group 13 in the longitudinal direction X of the release film 2 is not particularly limited. For example, the length of one adhesive film piece group 13 in the longitudinal direction X of the release film 2 can be 1 mm or more, 5 mm or more, or 10 mm or more. Further, the length of one adhesive film piece group 13 in the longitudinal direction X of the release film 2 can be 2000 mm or less, 500 mm or less, or 250 mm or less. These lower and upper limits can be combined appropriately. For example, the length of one adhesive film piece group 13 in the longitudinal direction X of the release film 2 can be 1 mm or more and 2000 mm or less, 5 mm or more and 500 mm or less, or 10 mm or more and 250 mm or less.

As illustrated in FIG. 21, the separation distance between the adjacent adhesive film piece groups 13 in the longitudinal direction X when the plurality of adhesive film pieces 3 are arranged in the longitudinal direction X of the release film 2 to form the plurality of adhesive film piece groups 13 is defined as a separation distance D2. In this case, when the adjacent adhesive film piece groups 13 are attached to different members, the separation distance D2 is preferably 20 mm or less, more preferably 10 mm or less, and further preferably 8 mm or less from the viewpoint of shortening the transportation distance of the film 1 and effectively using the film 1 to decrease cost. On the other hand, from the viewpoint of improving the workability in attaching the adhesive film piece 3, the separation distance D2 is preferably 0.1 mm or more, more preferably 0.5 mm or more, and further preferably 1 mm or more. These upper and lower limits can be combined appropriately. For example, the separation distance D2 is preferably 0.1 mm or more and 20 mm or less, more preferably 0.5 mm or more and 10 mm or less, and further preferably 1 mm or more and 8 mm or less.

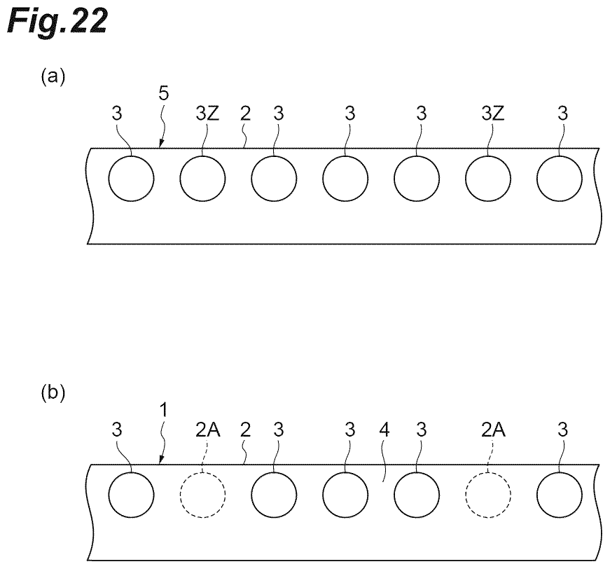

Further, the plurality of adhesive film pieces 3 may be arranged in one row in the longitudinal direction X of the release film 2 or may be arranged in a plurality of rows in the longitudinal direction X of the release film 2. Furthermore, when the plurality of adhesive film pieces 3 are arranged in one row in the longitudinal direction X of the release film 2, only the plurality of adhesive film pieces 3 arranged in one row may be provided on the release film 2. When the plurality of adhesive film pieces 3 are arranged in one row in the longitudinal direction X of the release film 2, the plurality of adhesive film pieces 3 may be arranged at the center of the release film 2 in the width direction Y as in the film 1 illustrated in FIG. 10(b) or may be arranged at a position shifted (offset) from the center of the release film 2 in the width direction Y as in the film 1 illustrated in FIG. 22(b). In these cases, the plurality of adhesive film pieces 3 and the half cut 2A of the original film 5 may be arranged at the center of the release film 2 in the width direction Y as in the original film 5 illustrated in FIG. 10(a) or may be arranged at a position shifted (offset) from the center of the release film 2 in the width direction Y as in the original film 5 illustrated in FIG. 22(a).

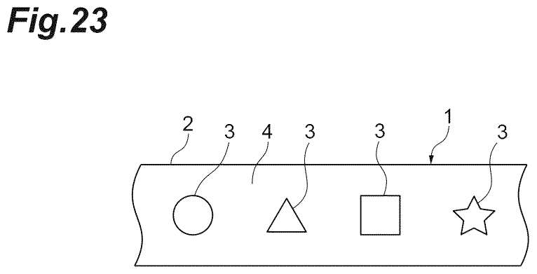

The plurality of adhesive film pieces 3 may have the same shape or different shapes. For example, the plurality of adhesive film pieces 3 may have different shapes as illustrated in FIG. 23. In this case, all of the adhesive film pieces 3 may have different shapes, or the adhesive film pieces 3 having different shapes may be mixed with the adhesive film pieces 3 having the same shape.

Further, the plurality of adhesive film pieces 3 may be arranged in one row in the width direction Y of the release film 2 or may be arranged in a plurality of rows in the width direction Y of the release film 2. For example, as illustrated in FIGS. 18 and 19, the plurality of adhesive film pieces 3 may be arranged in three rows in the width direction of the release film 2.

Further, the plurality of adhesive film pieces 3 may be separated from the edge of the release film 2 in the width direction Y of the release film 2. In this case, the separation distance between the edge of the release film 2 in the width direction Y of the release film 2 and the adhesive film piece 3 closest to the edge can be 0.1 mm or more and 10 mm or less, preferably 0.1 mm or more and 8 mm or less, and more preferably 0.2 mm or more and 5 mm or less.

The film 1 manufactured in this way is stored and transported as a wound body 15 in which the film is wound on the core 14 as illustrated in FIG. 24.

### Wound Body

As illustrated in FIG. 24, the wound body 15 includes the long (tape-like) film 1 and the core 14 on which the film 1 is wound. That is, the wound body 15 is formed by winding the film 1 on the core 14.

The core 14 includes a core material 14a and a pair of side plates 14b. The core material 14a is formed in a columnar shape. The film 1 is wound on the outer circumferential surface of the core material 14a. The pair of side plates 14b are attached to both ends of the core material 14a in the axial direction. The pair of side plates 14b support the film 1 from the left and right. The gap between the pair of side plates 14b is slightly wider than the width of the film 1.

### Connection Structure

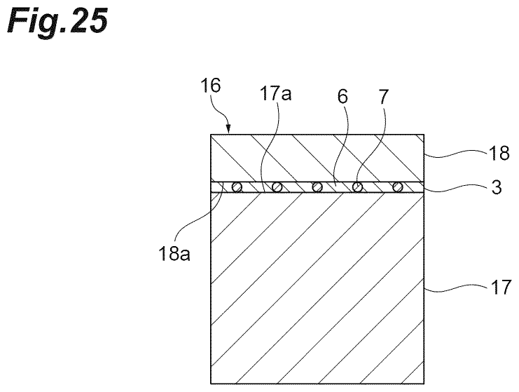

As illustrated in FIG. 25, a connection structure 16 includes a first member 17 that has a first attachment surface 17a, a second member 18 that has a second attachment surface 18a, and the adhesive film piece 3 which connects the first attachment surface 17a and the second attachment surface 18a.

The first member 17 is, for example, a chip component such as an IC chip, an LSI chip, a resistor chip, or a capacitor chip, a photoelectric conversion component such as an LED or an image sensor, a piezoelectric conversion component such as a strain sensor, a pressure sensor, an acoustic component, or a piezo element, a thermal sensor such as a thermometer or a heat sink, or a thermal management component. In the first member 17, a surface that faces the second member 18 is the first attachment surface 17a. For example, a first electrode (not illustrated) for electrical conduction with the second member 18 is disposed on the first attachment surface 17a.

The second member 18 is, for example, a substrate having optical transparency such as a glass substrate, a polyimide substrate, a polyamide-imide substrate, a polyethylene terephthalate substrate, a polycarbonate substrate, a cycloolefin polymer (COP) substrate, a polyethylene naphthalate substrate, a glass-reinforced epoxy substrate, a paper phenol substrate, a ceramic substrate, or a laminated plate, or a silicon substrate. In the second member 18, a surface that faces the first attachment surface 17a of the first member 17 is the second attachment surface 18a. A second electrode (not illustrated) for electrical conduction with the first member 17 is disposed on the second attachment surface 18a.

Furthermore, there is no clear distinction between the first member 17 and the second member 18, and any member may be used for each member.

The adhesive film piece 3 is the adhesive film piece 3 which is released from the film 1. The adhesive film piece 3 connects the first attachment surface 17a and the second attachment surface 18a by the adhesive 6. When the adhesive film piece 3 has anisotropic conductivity due to the inclusion of the conductive particles 7, the conductive particles 7 can establish electrical conductivity between the first electrode on the first attachment surface 17a and the second electrode on the second attachment surface 18a.

### Method for Manufacturing Connection Structure

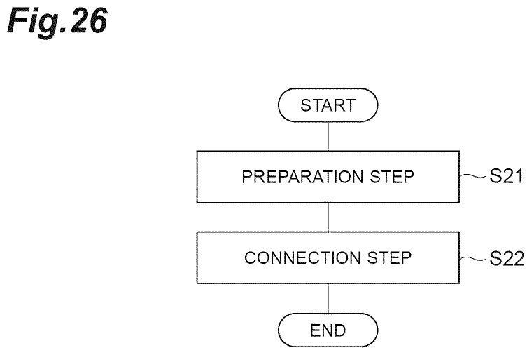

As illustrated in FIG. 26, the method for manufacturing the connection structure includes a preparation step (S21) and a connection step (S22) performed after the preparation step (S21).

In the preparation step (S21), the film 1 is prepared. At this time, the wound body 15 obtained by winding the film 1 is prepared as the film 1. Furthermore, in the preparation step (S21), the above-described film manufacturing method may be performed or only the film 1 manufactured by the above-described film manufacturing method may be prepared.

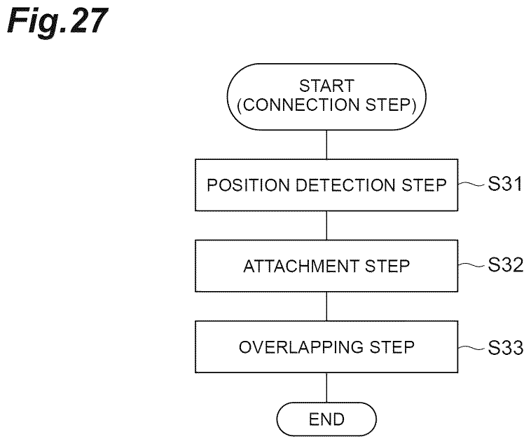

As illustrated in FIG. 27, the connection step (S22) includes a position detection step (S31), an attachment step (S32), and an overlapping step (S33).

In the position detection step (S31), first, the film 1 is unwound from the wound body 15. Then, as illustrated in FIG. 28, the position of the adhesive film piece 3 in the film 1 is detected by the image capturing device 33. At this time, the image capturing device 33 may be disposed on the side of the adhesive film piece 3 with respect to the release film 2 or may be disposed on the opposite side to the adhesive film piece 3 with respect to the release film 2. As illustrated in FIG. 28, in this embodiment, the image capturing device 33 is disposed on the opposite side to the adhesive film piece 3 with respect to the release film 2. In this case, since the release film 2 having optical transparency is used, the image capturing device 33 can detect the position of the adhesive film piece 3 in the film 1 from the side of the release film 2.

In the attachment step (S32), the adhesive film piece 3 is attached to the first attachment surface 17a based on the position detected by the position detection step (S31). Then, the release film 2 is released from the adhesive film piece 3 attached to the first attachment surface 17a.

In the overlapping step (S33), the first attachment surface 17a and the second attachment surface 18a are overlapped with each other through the adhesive film piece 3. Accordingly, the first attachment surface 17a and the second attachment surface 18a are connected by the adhesive 6 of the adhesive film piece 3. Then, the first member 17 and the second member 18 are pressed together and heat or light is applied to the adhesive 6 of the adhesive film piece 3 to cure the adhesive 6. Accordingly, it is possible to obtain the connection structure 16 in which the first attachment surface 17a and the second attachment surface 18a are connected to each other by the adhesive film piece 3. When the adhesive film piece 3 has anisotropic conductivity due to the inclusion of the conductive particles 7, the first member 17 and the second member 18 are pressed together to make the first member 17 and the second member 18 to be electrically conductive by the conductive particles 7 of the adhesive film piece 3 before the adhesive 6 is cured. Accordingly, the connection structure 16 is manufactured.

In this way, in the film manufacturing method according to this embodiment, it is possible to reduce the number of the adhesive film pieces 3 provided on the release film 2 by removing the removal target adhesive film piece 3Z from the original film 5. Then, it is possible to change the arrangement of the adhesive film pieces 3 provided on the release film 2 by changing the positions and number of the adhesive film pieces 3 that will become the removal target adhesive film pieces 3Z. Accordingly, it is possible to manufacture the film in which the adhesive film piece can be attached to various positions. In addition, for example, if there is a defective adhesive film piece 3 in the original film 5, it is possible to manufacture the film 1 in which the defective adhesive film piece 3 is removed by removing the defective adhesive film piece 3 as the removal target adhesive film piece 3Z.

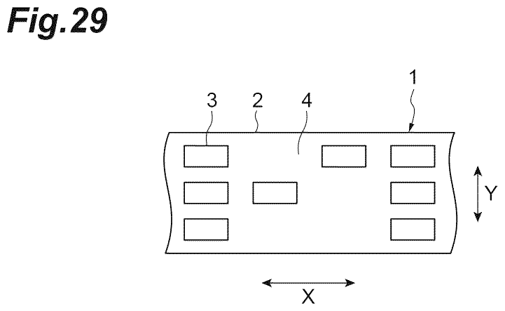

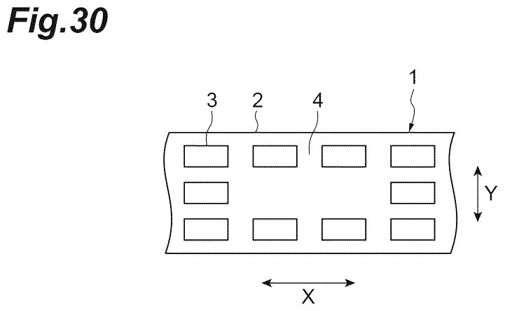

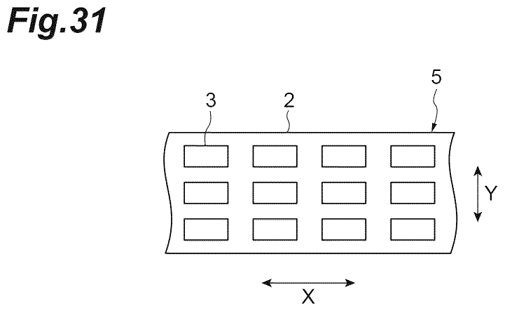

Incidentally, it is possible to change the arrangement of the adhesive film pieces 3 provided on the release film 2 by preparing a plurality of molds for punching out the adhesive film piece 3. However, a problem arises in that cost increases when preparing a plurality of molds. For example, when it is desired to realize the arrangement of the adhesive film pieces 3 illustrated in FIG. 29 and the arrangement of the adhesive film pieces 3 illustrated in FIG. 30, it is necessary to manufacture two molds. If more configurations are desired, it is necessary to manufacture more molds. In contrast, in the film manufacturing method, it is possible to change the arrangement of the adhesive film pieces 3 provided on the release film 2 by removing the removal target adhesive film piece 3Z from the original film 5. For example, when the original film 5 having the arrangement of the adhesive film pieces 3 illustrated in FIG. 31 is manufactured, it is possible to realize the arrangement of the adhesive film pieces 3 illustrated in any one of FIGS. 29 and 30 just by changing the positions and number of the removal target adhesive film pieces 3Z removed from the original film 5. Therefore, it is possible to suppress an increase in cost compared to the case in which a plurality of molds are prepared.

Further, a dispenser that drops a liquid adhesive can be used to provide a plurality of adhesives at any desired positions on the release film. However, in the liquid adhesives, high aspect ratio structures are difficult to be made, edges tend to become rounded due to surface tension, and dimensional accuracy decreases due to bleeding. In contrast, in the film manufacturing method, since the removal target adhesive film piece 3Z among the plurality of adhesive film pieces 3 provided on the release film 2 is removed, these problems can be solved.

Further, in the film manufacturing method, it is possible to appropriately remove the removal target adhesive film piece 3Z by transferring the removal target adhesive film piece 3Z from the original film 5 to the first adhesion roller 23. Further, since the removal target adhesive film piece 3Z transferred to the first adhesion roller 23 is transferred to the second adhesion roller 24, it is possible to suppress the removal target adhesive film piece 3Z transferred to the first adhesion roller 23 from being returned to the original film 5.

Further, in the film manufacturing method, since the removal target adhesive film piece 3Z is transferred from the original film 5 to the adhesion tape 25, the removal target adhesive film piece 3Z can be appropriately removed. Further, since the adhesion tape 25 is moved to contact and separate from the original film 5 while being transported, it is possible to suppress the removal target adhesive film piece 3Z transferred to the adhesion tape 25 from being returned to the original film 5.

Further, in the film manufacturing method, since the removal target adhesive film piece 3Z is detected and the detected removal target adhesive film piece 3Z is removed, the removal of the removal target adhesive film piece 3Z can be automated.

Further, in the film manufacturing method, since the adhesive film pieces 3 at the predetermined positions among the plurality of adhesive film pieces 3 are detected and removed as the removal target adhesive film pieces 3Z, the arrangement of the adhesive film pieces 3 provided on the release film 2 can be patterned. Accordingly, for example, it is possible to manufacture the film in which the plurality of adhesive film pieces 3 are attached to a plurality of members in the same pattern arrangement.

Further, in the film manufacturing method, since the adhesive film pieces 3 at the same position among the plurality of adhesive film piece groups 12 of the original film 5 are detected and removed as the removal target adhesive film pieces 3Z, the adhesive film pieces 3 of each adhesive film piece group 13 of the film 1 can be arranged in the same manner. Accordingly, for example, it is possible to manufacture the film 1 in which the plurality of adhesive film pieces 3 can be attached to a plurality of members in the same pattern arrangement.

Incidentally, the arrangement of the adhesive film pieces 3 in each adhesive film piece group 13 can be made the same by forming the adhesive film pieces 3 provided in each adhesive film piece group 13 by punching with a mold. However, since it is necessary to provide a large mold when one adhesive film piece group 13 is long in the longitudinal direction X of the release film 2, a problem arises in that cost increases. In contrast, in the film manufacturing method, the arrangement of the adhesive film pieces 3 in each adhesive film piece group 13 can be made the same just by removing the removal target adhesive film piece 3Z no matter how long one adhesive film piece group 13 is in the longitudinal direction X of the release film 2. Therefore, it is possible to suppress an increase in cost compared to the case in which a mold is prepared.

Further, in the film manufacturing method, since the defective adhesive film piece 3 is detected and removed as the removal target adhesive film piece 3Z, it is possible to manufacture the film without the defective adhesive film piece 3.

Incidentally, it is also possible to mark the defective adhesive film pieces 3 or the vicinity of the defective adhesive film pieces 3 by inkjet or laser marking, or the like, and to use the mark as a guide to prevent the defective adhesive film pieces 3 from being attached. However, when marking is performed by inkjet or laser marking, there are problems such as foreign matter defects due to inkjet ink, burning due to the laser, foreign matter defects due to dust generation, and damage to the release film. In contrast, in the film manufacturing method, since the defective adhesive film piece 3 is detected and removed as the removal target adhesive film piece 3Z, these problems can be solved.

Further, in the film manufacturing method, since the original film manufacturing step of manufacturing the original film 5 is provided, it is possible to freely set the arrangement of the plurality of adhesive film pieces 3 in the original film 5.

Further, in the film manufacturing method, the adhesive film layer 3A is formed on the entire surface of the release film 2, the adhesive film layer 3A is cut along the outline 3B, and the margin portion 3A2 is released from the release film 2 along the cut outline 3B. Accordingly, it is possible to easily provide the plurality of adhesive film pieces 3 on the release film 2.

Further, in the film manufacturing method, since the plurality of adhesive film pieces 3 are conductive, the members connected through the adhesive film piece 3 can be made electrically conductive.

In the film 1 according to this embodiment, since the separation distance between the first adhesive film piece 101 and the second adhesive film piece 102 is different from the separation distance between the third adhesive film piece 103 and the fourth adhesive film piece 104, the adhesive film piece 3 can be attached to various positions compared to the case in which the plurality of adhesive film pieces 3 have the same separation distance.

Further, in this film 1, since the first adhesive film piece 101 and the second adhesive film piece 102 are adjacent to each other in the longitudinal direction X and the third adhesive film piece 103 and the fourth adhesive film piece 104 are adjacent to each other in the longitudinal direction X, the adhesive film piece 3 can be attached to various positions of the longitudinal direction X.

On the other hand, in the film 1, since the first adhesive film piece 101 and the second adhesive film piece 102 are adjacent to each other in the width direction Y of the release film 2, and the third adhesive film piece 103 and the fourth adhesive film piece 104 are adjacent to each other in the width direction Y, the adhesive film piece 3 can be attached to various positions of the width direction Y.

Further, in this film 1, since the non-adhesive region 4 has the first region in which the separation distance between the adjacent adhesive film pieces 3 is longer than the adhesive film piece 3, the adhesive film piece 3 can be attached to more various positions.

Further, in this film 1, since the non-adhesive region 4 has the second region in which the separation distance between the adjacent adhesive film pieces 3 is shorter than the adhesive film piece 3, the adhesive film piece 3 can be attached to more various positions.

In the film 1, since the non-adhesive region 4 has the third region A3 in which the separation distance between the adjacent adhesive film pieces 3 is shorter than the separation distance between the adjacent adhesive film pieces 3 in the first region A1, the adhesive film piece 3 can be attached to more various positions.

Further, in this film 1, the separation distance between the first adhesive film piece 101 and the second adhesive film piece 102 is longer than the maximum length of the first adhesive film piece 101 and the second adhesive film piece 102 in the direction in which the first adhesive film piece 101 and the second adhesive film piece 102 are separated from each other. Therefore, the first adhesive film piece 101 and the second adhesive film piece 102 can be attached to a position farther than the maximum length of the first adhesive film piece 101 and the second adhesive film piece 102 in the direction in which the first adhesive film piece 101 and the second adhesive film piece 102 are separated from each other without attaching the adhesive film piece 3 between the first adhesive film piece 101 and the second adhesive film piece 102.

Further, in this film 1, the separation distance between the third adhesive film piece 103 and the fourth adhesive film piece 104 is shorter than the maximum length of the third adhesive film piece 103 and the fourth adhesive film piece 104 in the direction in which the third adhesive film piece 103 and the fourth adhesive film piece 104 are separated from each other. Therefore, the third adhesive film piece 103 and the fourth adhesive film piece 104 can be attached at a position closer than the maximum length of the third adhesive film piece 103 and the fourth adhesive film piece 104 in the direction in which the third adhesive film piece 103 and the fourth adhesive film piece 104 are separated from each other without attaching the adhesive film piece 3 between the third adhesive film piece 103 and the fourth adhesive film piece 104.

Further, in this film 1, since the separation distance between the third adhesive film piece 103 and the fourth adhesive film piece 104 is shorter than the separation distance between the first adhesive film piece 101 and the second adhesive film piece 102, the adhesive film piece 3 can be attached to more various positions.

Further, in this film 1, the half cut 2A is formed in the non-adhesive region 4 between the first adhesive film piece 101 and the second adhesive film piece 102. Therefore, for example, when another adhesive film piece 3 provided between the first adhesive film piece 101 and the second adhesive film piece 102 is removed during the manufacturing of the film 1, it is possible to determine whether or not the trace is due to the removal of the adhesive film piece 3.

Further, in this film 1, the third adhesive film piece 103 and the fourth adhesive film piece 104 are adjacent to each other in the longitudinal direction X, and the separation distance between the third adhesive film piece 103 and the fourth adhesive film piece 104 in the longitudinal direction X is 10 mm or less. Therefore, the transportation distance of the film 1 when attaching the third adhesive film piece 103 and the fourth adhesive film piece 104 can be shortened, and the film 1 can be effectively used to decrease cost.

Further, in this film 1, since the arrangement of the adhesive film pieces 3 is the same in the plurality of adhesive film piece groups 13, the adhesive film piece 3 can be efficiently attached to the member having the same attachment position of the adhesive film piece 3.

Further, in this film 1, the separation distance of the adjacent adhesive film piece groups 13 in the longitudinal direction X of the release film 2 is 10 mm or less. Therefore, when the adjacent adhesive film piece groups 13 are attached to different members, the transportation distance of the film 1 can be shortened, and the film 1 can be effectively used to decrease cost.

Further, in this film 1, since the plurality of adhesive film pieces 3 are separated from the edges of the release film 2 in the width direction Y of the release film 2, it is possible to suppress the adhesive film piece 3 from being released from the release film 2 when the ends of the release film 2 interfere with other members.

Further, in this film 1, since the plurality of adhesive film pieces 3 are arranged in one row in the longitudinal direction X of the release film 2, the adhesive film piece 3 can be easily attached.

Further, in this film 1, since at least a part of the plurality of adhesive film pieces 3 has the hole 3a, for example, the adhesive film piece 3 can be appropriately attached to a portion having a center portion where the adhesive film piece 3 is not desired to be attached.

Further, in this film 1, since the plurality of adhesive film pieces 3 have the same shape, the adhesive film piece 3 can be efficiently attached to a plurality of attachment surfaces having the same shape.

Further, in this film 1, since the adhesive film piece 3 is conductive, two members can be made electrically conductive through the adhesive film piece 3.

Further, in this film 1, since the adhesive film piece 3 contains the conductive particles 7, the adhesive film piece 3 can have anisotropic conductivity.

In the wound body 15 according to this embodiment, since any one of the above-described films 1 is wound on the core 14, the adhesive film piece 3 can be attached to various positions.

In the connection structure 16 according to this embodiment, since the first member 17 and the second member 18 are connected by any one of the above-described adhesive film pieces 3, it is possible to obtain the connection structure 16 in which the adhesive film piece 3 is appropriately attached to the first attachment surface 17a and the second attachment surface 18a even when the positions of the first attachment surface 17a and the second attachment surface 18a are various.

In the method for manufacturing the connection structure according to this embodiment, since the first attachment surface 17a of the first member 17 and the second attachment surface 18a of the second member 18 are connected through the adhesive film piece 3 of any one of the above-described films 1, it is possible to manufacture the connection structure 16 in which the adhesive film piece 3 is appropriately attached to the first attachment surface 17a and the second attachment surface 18a even when the positions of the first attachment surface 17a and the second attachment surface 18a are various.

The present disclosure is not limited to the above-described embodiment, and can be modified as appropriate without departing from the spirit of the present disclosure.

For example, in the above-described embodiment, an example of the shape, number, arrangement, or the like of the original film and the plurality of adhesive film pieces in the film has been described, but the shape, number, arrangement, or the like of the original film and the multiple adhesive film pieces in the film are not particularly limited.

Further, for example, in the above-described embodiment, an example of the connection step in the method for manufacturing the connection structure has been described, but the connection step may be realized by any method as long as it is possible to use the film and connect the first member and the second member with the adhesive film piece of the film.

Further, for example, in the above-described embodiment, the original film and the film have been described as a two-layer structure in which the plurality of adhesive film pieces are provided on the release film, but may be a three-layer structure in which the second release film is further provided on the plurality of adhesive films.

### EXAMPLES

Here, a production tact time was calculated for manufacturing a film by removing defective adhesive film pieces from an original film by the third removing method using the removing device 20C illustrated in FIG. 13. In this calculation, the wound body 15 obtained by winding a roll of 100 m of the original film was used. This original film had 10000 adhesive film pieces, and 10000 adhesive film pieces were arranged in one row in the longitudinal direction of the release film at the center in the width direction of the release film to be separated from each other. Further, this original film was determined to have a 90% yield rate of adhesive film pieces. In other words, among 10000 adhesive film pieces, 9000 adhesive film pieces were determined to be non-defective and 1000 adhesive film pieces were determined to be defective. Then, the unwinding speed of the original film from the wound body, i.e., the transportation speed of the original film, was set to 9 m/min, and the defective adhesive film pieces were removed as the removal target adhesive film pieces by the removing device 20C. As a result, since there was no need to stop the transportation of the original film when removing the removal target adhesive film piece, the production tact time was 100/9≈11.1 min/turn. In other words, it took 11.1 min per turn of the wound body.

Furthermore, the production tact time for attaching the adhesive film piece to the member using the film manufactured in this way was calculated. In this calculation, the time for attaching the adhesive film piece to the member was set to 5 sec/piece, and the transportation time for the portion of the film from which the removal target adhesive film piece had been removed was set to 0.5 sec/piece. As a result, the production tact time was 9000×5+1000×0.5=45500 sec/turn≈758.3 hours/turn. That is, it took 758.3 hours per turn of the wound body.

### INDUSTRIAL APPLICABILITY

The present disclosure can be used as, for example, the film manufacturing method, the film, the wound body, the connection structure, and the method for manufacturing the connection structure.

### REFERENCE SIGNS LIST

1: film, 2: release film, 2A: half cut, 3: adhesive film piece, 3a: hole, 3A: adhesive film layer, 3A1: inner portion, 3A2: margin portion, 3B: outline, 3Z: removal target adhesive film piece, 4: non-adhesive region, 5: original film, 6: adhesive, 7: conductive particle, 8: conductive adhesive region, 9: non-conductive adhesive region, 10: wound body, 11: wound body, 12: adhesive film piece group, 13: adhesive film piece group, 14: core, 14a: core material, 14b: side plate, 15: wound body, 16: connection structure, 17: first member, 17a: first attachment surface, 18: second member, 18a: second attachment surface, 20A: removing device, 20B: removing device, 20C: removing device, 20D: removing device, 20E: removing device, 20F: removing device, 21: unwinding shaft, 22: winding shaft, 23: first adhesion roller, 24: second adhesion roller, 25: adhesion tape, 26: tape transportation mechanism, 27: wound body, 28: unwinding shaft, 29: pressure roller, 30: winding shaft, 31: sensor, 32: inspection machine, 33: image capturing device, 101: first adhesive film piece, 102: second adhesive film piece, 103: third adhesive film piece, 104: fourth adhesive film piece, A1: first region, A2: second region, A3: third region, D1: separation distance, D2: separation distance, X: longitudinal direction, Y: width direction.

1. A film manufacturing method comprising:
a removing step of removing at least one removal target adhesive film piece among a plurality of adhesive film pieces from an original film having a plurality of adhesive film pieces provided on a long release film.

2. The film manufacturing method according to claim 1,
wherein in the removing step, the removal target adhesive film piece is removed from the original film by transferring the removal target adhesive film piece to an adhesion body to be able to contact and separate from the original film.

3. The film manufacturing method according to claim 2,
wherein in the removing step, the removal target adhesive film piece transferred to a first adhesion roller is transferred to a second adhesion roller not contacting the original film by using the first adhesion roller as the adhesion body.

4. The film manufacturing method according to claim 2,
wherein in the removing step, an adhesion tape is brought into contact with and separate from the original film while being transported by using the adhesion tape as the adhesion body.

5. The film manufacturing method according to claim 1, further comprising:
a detection step of detecting the removal target adhesive film piece,
wherein in the removing step, the removal target adhesive film piece detected by the detection step is removed from the original film.

6. The film manufacturing method according to claim 5,
wherein in the detection step, the adhesive film piece at a predetermined position among the plurality of adhesive film pieces is detected as the removal target adhesive film piece.

7. The film manufacturing method according to claim 5,
wherein in the detection step, when the plurality of adhesive film pieces are divided into a plurality of adhesive film piece groups arranged in a longitudinal direction of the release film, the adhesive film piece at the same position among the plurality of adhesive film piece groups is detected as the removal target adhesive film piece.

8. The film manufacturing method according to claim 5,
wherein in the detection step, a defective adhesive film piece among the plurality of adhesive film pieces is detected as the removal target adhesive film piece.

9. The film manufacturing method according to claim 1, further comprising:
an original film manufacturing step of manufacturing the original film.

10. The film manufacturing method according to claim 9,
wherein the original film manufacturing step includes an adhesive film layer forming step of forming an adhesive film layer on an entire surface of the release film, an adhesive film layer cutting step of cutting the adhesive film layer along an outline forming an outer shape of the plurality of adhesive film pieces, and a margin releasing step of releasing a margin portion as a portion other than the plurality of adhesive film pieces in the adhesive film layer from the release film along the cut outline.

11. The film manufacturing method according to claim 1,
wherein the plurality of adhesive film pieces are conductive.

12. A film comprising:
a long release film;
a plurality of adhesive film pieces which are provided on the release film and separated from each other; and
a non-adhesive region which is provided on the release film not to have the plurality of adhesive film pieces,
wherein the plurality of adhesive film pieces include a first adhesive film piece and a second adhesive film piece which are adjacent to each other through the non-adhesive region and a third adhesive film piece and a fourth adhesive film piece which are adjacent to each other through the non-adhesive region, and
wherein a separation distance between the first adhesive film piece and the second adhesive film piece is different from a separation distance between the third adhesive film piece and the fourth adhesive film piece.

13. The film according to claim 12,
wherein the first adhesive film piece and the second adhesive film piece are adjacent to each other in a longitudinal direction of the release film, and
wherein the third adhesive film piece and the fourth adhesive film piece are adjacent to each other in the longitudinal direction.

14. The film according to claim 12,
wherein the first adhesive film piece and the second adhesive film piece are adjacent to each other in a width direction of the release film, and
wherein the third adhesive film piece and the fourth adhesive film piece are adjacent to each other in the width direction.

15. The film according to claim 12,
wherein the non-adhesive region has a first region in which a separation distance between the adjacent adhesive film pieces is longer than the adhesive film piece.

16. The film according to claim 15,
wherein the non-adhesive region has a second region in which a separation distance between the adjacent adhesive film pieces is shorter than the adhesive film piece.

17. The film according to claim 15,
wherein the non-adhesive region has a third region in which a separation distance between the adjacent adhesive film pieces is shorter than the separation distance between the adjacent adhesive film pieces in the first region.

18. The film according to claim 12,
wherein a separation distance between the first adhesive film piece and the second adhesive film piece is longer than a maximum length of the first adhesive film piece and the second adhesive film piece in a direction in which the first adhesive film piece and the second adhesive film piece are separated from each other.

19. The film according to claim 18,
wherein a separation distance between the third adhesive film piece and the fourth adhesive film piece is shorter than a maximum length of the third adhesive film piece and the fourth adhesive film piece in a direction in which the third adhesive film piece and the fourth adhesive film piece are separated from each other.

20. The film according to claim 18,
wherein a separation distance between the third adhesive film piece and the fourth adhesive film piece is shorter than the separation distance between the first adhesive film piece and the second adhesive film piece.

21. The film according to claim 18, further comprising:
a half cut which is formed in the release film,
wherein the half cut is formed in the non-adhesive region between the first adhesive film piece and the second adhesive film piece.

22. The film according to claim 18,
wherein the third adhesive film piece and the fourth adhesive film piece are adjacent to each other in the longitudinal direction of the release film, and
wherein a separation distance between the third adhesive film piece and the fourth adhesive film piece in the longitudinal direction is 20 mm or less.

23. The film according to claim 12,
wherein the plurality of adhesive film pieces form a plurality of adhesive film piece groups arranged in the longitudinal direction of the release film, and
wherein the arrangement of the adhesive film pieces is the same in the plurality of adhesive film piece groups.

24. The film according to claim 23,
wherein a separation distance between the adhesive film piece groups adjacent to each other in the longitudinal direction of the release film is 20 mm or less.

25. The film according to claim 12,
wherein the plurality of adhesive film pieces are separated from the edges of the release film in the width direction of the release film.

26. The film according to claim 12,
wherein the plurality of adhesive film pieces are arranged in one row in the longitudinal direction of the release film.

27. The film according to claim 12,
wherein at least a part of the plurality of adhesive film pieces has a hole.

28. The film according to claim 12,
wherein the plurality of adhesive film pieces have the same shape.

29. The film according to claim 12,
wherein the adhesive film piece is conductive.

30. The film according to claim 29,
wherein the adhesive film piece contains conductive particles.

31. A wound body comprising:
the film according to claim 12; and
a core on which the film is wound.

32. A connection structure comprising:
a first member that has a first attachment surface;
a second member that has a second attachment surface; and
the adhesive film piece according to claim 12 that connects the first attachment surface and the second attachment surface.

33. A method for manufacturing a connection structure comprising:
a preparation step of preparing the film according to claim 12; and
a connection step of connecting a first attachment surface of a first member and a second attachment surface of a second member through the adhesive film piece of the film.

34. A removing device comprising:
an unwinding shaft on which a wound body, formed by winding an original film having a plurality of adhesive film pieces provided on a long release film, is set;
a winding shaft which winds up the original film unwound from the wound body;
a first adhesion roller to which at least one removal target adhesive film piece among the plurality of adhesive film pieces is transferred from the original film;
a second adhesion roller to which the removal target adhesive film piece transferred to the first adhesion roller is transferred by contacting or approaching the first adhesion roller; and
a drive mechanism which moves the first adhesion roller to be able to contact and separate from the original film reaching the winding shaft from the unwinding shaft.

35. The removing device according to claim 34, further comprising:
a sensor which detects the adhesive film piece at a predetermined position among the plurality of adhesive film pieces as the removal target adhesive film piece,
wherein the drive mechanism moves the first adhesion roller close to the original film so that the first adhesion roller contacts the removal target adhesive film at a timing at which the removal target adhesive film piece detected by the sensor reaches.

36. The removing device according to claim 34, further comprising:
an inspection machine which inspects the plurality of adhesive film pieces provided on the original film and detects the adhesive film piece determined to be defective as the removal target adhesive film piece,
wherein the drive mechanism moves the first adhesion roller close to the original film so that the first adhesion roller contacts the removal target adhesive film piece at a timing at which the removal target adhesive film piece detected by the inspection machine reaches.

37. A removing device comprising:
an unwinding shaft on which a wound body, formed by winding an original film having a plurality of adhesive film pieces provided on a long release film, is set;
a winding shaft which winds up the original film unwound from the wound body;
an adhesion tape to which at least one removal target adhesive film piece among the plurality of adhesive film pieces is transferred from the original film; and
a drive mechanism which moves the adhesion tape to be able to contact and separate from the original film reaching the winding shaft from the unwinding shaft.

38. The removing device according to claim 37, further comprising:
a sensor which detects the adhesive film piece at a predetermined position among the plurality of adhesive film pieces as the removal target adhesive film piece,
wherein the drive mechanism moves the adhesion tape close to the original film so that the adhesion tape contacts the removal target adhesive film at a timing at which the removal target adhesive film piece detected by the sensor reaches.

39. The removing device according to claim 37, further comprising:
an inspection machine which inspects the plurality of adhesive film pieces provided on the original film and detects the adhesive film piece determined to be defective as the removal target adhesive film piece,
wherein the drive mechanism moves the adhesion tape close to the original film so that the adhesion tape contacts the removal target adhesive film piece at a timing at which the removal target adhesive film piece detected by the inspection machine reaches.
